(19) United States
(12) Patent Application Publication
(10) Pub. No.: US 2026/0012721 A1
(43) Pub. Date: Jan. 8, 2026

(54) WEARABLE ELECTRONIC DEVICE

(71) Applicant: Samsung Electronics Co., Ltd., Suwon-si (KR)

(72) Inventor: Youngjin OH, Suwon-si (KR)

(21) Appl. No.: 19/264,347

(22) Filed: Jul. 9, 2025

Related U.S. Application Data
(63) Continuation of application No. PCT/KR2025/009520, filed on Jul. 3, 2025.

(30) Foreign Application Priority Data
Jul. 4, 2024 (KR) 10-2024-0088270
Jul. 9, 2024 (KR) 10-2024-0090729
Sep. 10, 2024 (KR) 10-2024-0123414

(51) Int. Cl. H04R 1/10; G06F 1/16; H04R 1/04

(52) U.S. Cl. CPC H04R 1/1016; G06F 1/163; G06F 1/1698; H04R 1/04; H04R 1/1025; H04R 1/1041; H04R 2420/07

(57) ABSTRACT

A wearable electronic device is provided. The wearable electronic device includes a first antenna structure disposed on an antenna carrier, a printed circuit board, a semiconductor packaging substrate packaged with the printed circuit board, a second antenna structure disposed on at least a portion of a surface of the semiconductor packaging substrate, and a contact structure electrically connecting the first antenna structure and the second antenna structure.

### CROSS-REFERENCE TO RELATED APPLICATION(S)

This application is a continuation application, claiming priority under 35 U.S.C. § 365 (c), of an International application No. PCT/KR2025/009520, filed on Jul. 3, 2025, which is based on and claims the benefit of a Korean patent application number 10-2024-0088270, filed on Jul. 4, 2024, in the Korean Intellectual Property Office, of a Korean patent application number 10-2024-0090729, filed on Jul. 9, 2024, in the Korean Intellectual Property Office, and of a Korean patent application number 10-2024-0123414, filed on Sep. 10, 2024, in the Korean Intellectual Property Office, the disclosure of each of which is incorporated by reference herein in its entirety.

### TECHNICAL FIELD

The disclosure relates to a wearable electronic device capable of improving antenna performance.

### BACKGROUND ART

A general wearable electronic device may have an antenna pattern disposed on an antenna carrier. Since the antenna pattern is only disposed on the antenna carrier, the area of the antenna pattern may be small, resulting in low antenna performance. The wearable electronic device may have limited inner space, making it difficult to provide sufficient area for the antenna pattern. Since the area of the antenna pattern is small, the antenna performance may be reduced, resulting in deteriorated data transmission performance and sound interruption.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Solution

As a wearable electronic device (e.g., a true wireless stereo (TWS) wireless earphone) becomes more functional, it may include a variety of sensor components including high-performance speakers, multiple microphones (e.g., inner and outer microphones), sensors (e.g., proximity sensors, electrode sensors, biometric sensors) for various status detection or bio-signal acquisition, and sensors (e.g., touch sensors) for touch detection.

In order to improve the wearing comfort of the wearable electronic device (e.g., the TWS wireless earphone), the unit size (e.g., the wireless earphone unit) is being miniaturized. In the case of a small wearable electronic device (e.g., a TWS wireless earphone), since the antenna pattern is disposed only on the antenna carrier, the area of the antenna pattern is small, and the antenna performance may be low.

In order to dispose various electronic components within a limited inner space of a wearable electronic device (e.g., a TWS wireless earphone), a semiconductor packaging substrate (e.g., a system in package (SiP)) substrate) may be applied to the wearable electronic device (e.g., the TWS wireless earphone). When the antenna pattern is positioned close to the user's human body, a conformal metal shielding must be disposed to remove noise, which may lower the radio frequency (RF) performance of the wearable electronic device (e.g., the TWS wireless earphone). When a semiconductor packaging substrate (e.g., a SiP substrate) is applied to the wearable electronic device (e.g., the TWS wireless earphone), the RF port of the main integrated circuit (IC) and the antenna area are separated by a long distance, so that path loss to the antenna may occur (e.g., path loss may occur because the path to the antenna is long).

Aspects of the disclosure are to address at least the above-mentioned problems and/or disadvantages and to provide at least the advantages described below. Accordingly, an aspect of the disclosure is to provide a wearable electronic device capable of increasing the area of an antenna pattern and improving antenna performance by disposing an antenna pattern on a semiconductor packaging substrate (e.g., a system in package (SiP)) substrate) of the wearable electronic device.

Another aspect of the disclosure is to provide a wearable electronic device capable of increasing the area of an antenna pattern and improving antenna performance by disposing an antenna pattern on an antenna carrier and a semiconductor packaging substrate (e.g., a SiP substrate) of the wearable electronic device.

Additional aspects will be set forth in part in the description which follows and, in part, will be apparent from the description, or may be learned by practice of the presented embodiments.

In accordance with an aspect of the disclosure, a wearable electronic device is provided. The wearable electronic device includes a first antenna structure disposed on an antenna carrier, a printed circuit board, a semiconductor packaging substrate packaged with the printed circuit board, a second antenna structure disposed on at least a portion of a surface of the semiconductor packaging substrate, and a contact structure electrically connecting the first antenna structure and the second antenna structure.

In accordance with another aspect of the disclosure, a wearable electronic device is provided. The wearable electronic device includes a printed circuit board, a semiconductor packaging substrate packaged with the printed circuit board, an antenna structure disposed on at least a portion of a surface of the semiconductor packaging substrate, and a contact structure electrically connecting the printed circuit board and the antenna structure.

According to one embodiment of the present disclosure, a wearable electronic device (a TWS wireless earphone) has a second antenna structure (e.g., a second antenna pattern) disposed on at least a portion of a second surface (e.g., a rear surface) and/or a third surface (e.g., a side surface) of a semiconductor packaging substrate (e.g., a SiP substrate), thereby increasing an area of an overall antenna pattern of the wearable electronic device and improving antenna performance.

The disclosure relates to a wearable electronic device that increases the area of an antenna pattern and improve antenna performance by disposing an antenna pattern on an antenna carrier and a semiconductor packaging substrate (e.g., a SiP substrate).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device within a network environment according to an embodiment of the disclosure;

FIG. 2 is a diagram illustrating an electronic device including a wearable electronic device (e.g., a TWS wireless earphone) and a cradle according to an embodiment of the disclosure;

FIG. 3A is a block diagram of a wearable electronic device (e.g., a TWS wireless earphone, a first wireless earphone unit, a left wireless earphone unit) according to an embodiment of the disclosure;

FIG. 3B is a block diagram of a wearable electronic device (e.g., a TWS wireless earphone, a second wireless earphone unit, a right wireless earphone unit) according to an embodiment of the disclosure;

FIGS. 4, 5, and 6 are diagrams illustrating a wearable electronic device (e.g., a TWS wireless earphones, a wireless earphone unit) according to various embodiments of the disclosure;

FIG. 7 is an exploded perspective view of a wearable electronic device (e.g., a TWS wireless earphone, a wireless earphone unit) according to an embodiment of the disclosure;

FIG. 8 is a diagram illustrating an antenna carrier disposed on a stem part of a wearable electronic device (e.g., a TWS wireless earphone, a wireless earphone unit) and a first antenna structure (e.g., an antenna pattern) disposed on the antenna carrier according to an embodiment of the disclosure;

FIG. 9 is a diagram illustrating a printed circuit board and a semiconductor packaging substrate (e.g., a SiP substrate) and illustrating electronic components disposed on a first surface (e.g., a front surface) of the printed circuit board according to an embodiment of the disclosure;

FIG. 10 is a diagram illustrating a printed circuit board and a semiconductor packaging substrate (e.g., a SiP substrate) and illustrating a second surface (e.g., a rear surface) of a semiconductor packaging substrate (e.g., a SiP substrate) according to an embodiment of the disclosure;

FIG. 11 is a diagram illustrating a printed circuit board and a semiconductor packaging substrate (e.g., a SiP substrate) and illustrating a third surface (e.g., a side surface) of a semiconductor packaging substrate (e.g., a SiP substrate) according to an embodiment of the disclosure;

FIG. 12 is a diagram illustrating a wearable electronic device, wherein a first antenna structure is disposed on an antenna carrier and an antenna structure is disposed on a semiconductor packaging substrate (e.g., a SiP substrate) according to an embodiment of the disclosure;

FIG. 13 is a diagram illustrating a first antenna structure disposed on an antenna carrier and a second antenna structure disposed on an outer surface (e.g., a second surface (rear surface), a third surface (side surface)) of a semiconductor packaging substrate (e.g., a SiP substrate) according to an embodiment of the disclosure;

FIG. 14 is a circuit diagram of a first antenna structure disposed on an antenna carrier and a second antenna structure disposed on a semiconductor packaging substrate (e.g., a SiP substrate) of a wearable electronic device according to an embodiment of the disclosure;

FIG. 15 is a diagram illustrating a first antenna structure disposed on an antenna carrier and a second antenna structure disposed on an outer surface (e.g., a second surface (rear surface), a third surface (side surface)) of a semiconductor packaging substrate (e.g., a SiP substrate) according to an embodiment of the disclosure;

FIG. 16 is a circuit diagram of a first antenna structure disposed on an antenna carrier and a second antenna structure disposed on a semiconductor packaging substrate (e.g., a SiP substrate) of a wearable electronic device according to an embodiment of the disclosure;

FIG. 17 is a diagram illustrating a first antenna structure disposed on an antenna carrier and a second antenna structure disposed on an outer surface (e.g., a second surface (rear surface), a third surface (side surface)) of a semiconductor packaging substrate (e.g., a SiP substrate) according to an embodiment of the disclosure;

FIG. 18 is a circuit diagram of a first antenna structure disposed on an antenna carrier and a second antenna structure disposed on a semiconductor packaging substrate (e.g., a SiP substrate) of a wearable electronic device according to an embodiment of the disclosure;

FIG. 19 is a diagram illustrating a first antenna structure disposed on an antenna carrier and a second antenna structure disposed on an outer surface (e.g., a second surface (rear surface), a third surface (side surface)) of a semiconductor packaging substrate (e.g., a SiP substrate) according to an embodiment of the disclosure;

FIGS. 20 and 21 are diagrams illustrating a second antenna structure, a contact structure, and a connection pattern electrically connecting the second antenna structure and the contact structure to an outer surface (e.g., a second surface (rear surface), a third surface (side surface)) of a semiconductor packaging substrate (e.g., a SiP substrate) according to various embodiments of the disclosure;

FIG. 22 is a diagram illustrating an antenna structure disposed on an outer surface (e.g., a second surface (rear surface), a third surface (side surface)) of a semiconductor packaging substrate (e.g., a SiP substrate) according to an embodiment of the disclosure;

FIG. 23 is a diagram illustrating an antenna structure disposed on an outer surface (e.g., a second surface (rear surface), a third surface (side surface)) of a semiconductor packaging substrate (e.g., a SiP substrate) according to an embodiment of the disclosure;

FIG. 24 is a diagram illustrating an antenna structure disposed on an outer surface (e.g., a second surface (rear surface), a third surface (side surface)) of a semiconductor packaging substrate (e.g., a SiP substrate) according to an embodiment of the disclosure;

FIG. 25 is a diagram illustrating an antenna structure disposed on an outer surface (e.g., a second surface (rear surface), a third surface (side surface)) of a semiconductor packaging substrate (e.g., a SiP substrate) according to an embodiment of the disclosure;

FIG. 26 is a diagram illustrating an antenna structure disposed on an outer surface (e.g., a second surface (rear surface), a third surface (side surface)) of a semiconductor packaging substrate (e.g., a SiP substrate) according to an embodiment of the disclosure;

FIG. 27 is a diagram illustrating an antenna structure disposed on an outer surface (e.g., a second surface (rear surface), a third surface (side surface)) of a semiconductor packaging substrate (e.g., a SiP substrate) according to an embodiment of the disclosure;

FIG. 28 is a diagram illustrating an antenna structure disposed on an outer surface (e.g., a second surface (rear surface), a third surface (side surface)) of a semiconductor packaging substrate (e.g., a SiP substrate) according to an embodiment of the disclosure; and

FIG. 29 is a diagram illustrating a comparison of the performance of an antenna of a wearable electronic device of a comparative example and an antenna of a wearable electronic device (e.g., the wearable electronic device 400 of FIG. 4) according to an embodiment of the disclosure.

The same reference numerals are used to represent the same elements throughout the drawings.

### MODE FOR THE INVENTION

The following description with reference to the accompanying drawings is provided to assist in a comprehensive understanding of various embodiments of the disclosure as defined by the claims and their equivalents. It includes various details to assist in that understanding but these are to be regarded as exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

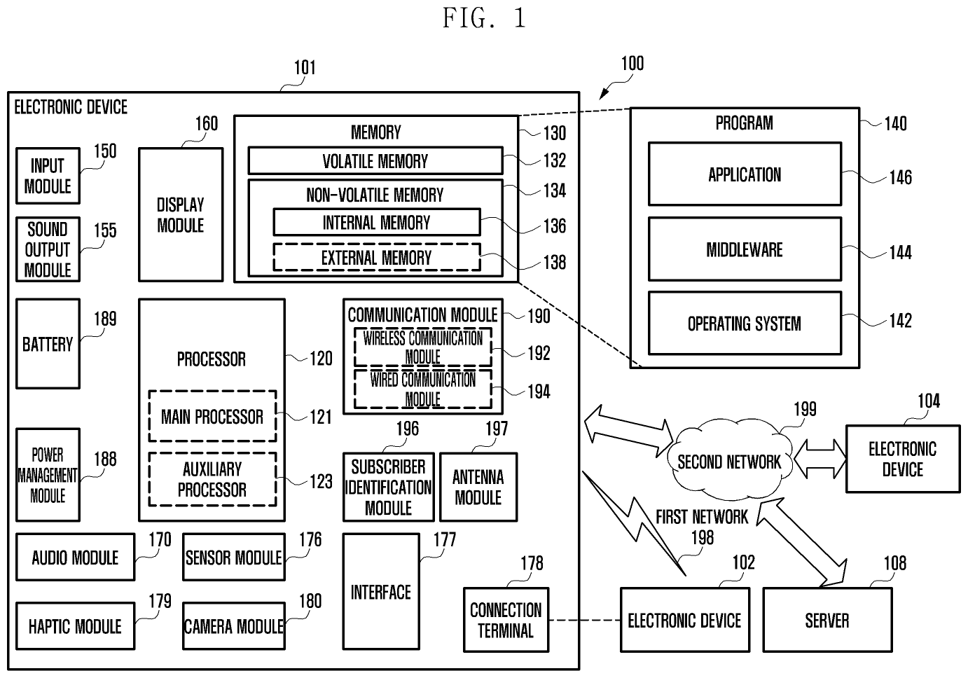

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “Ist” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

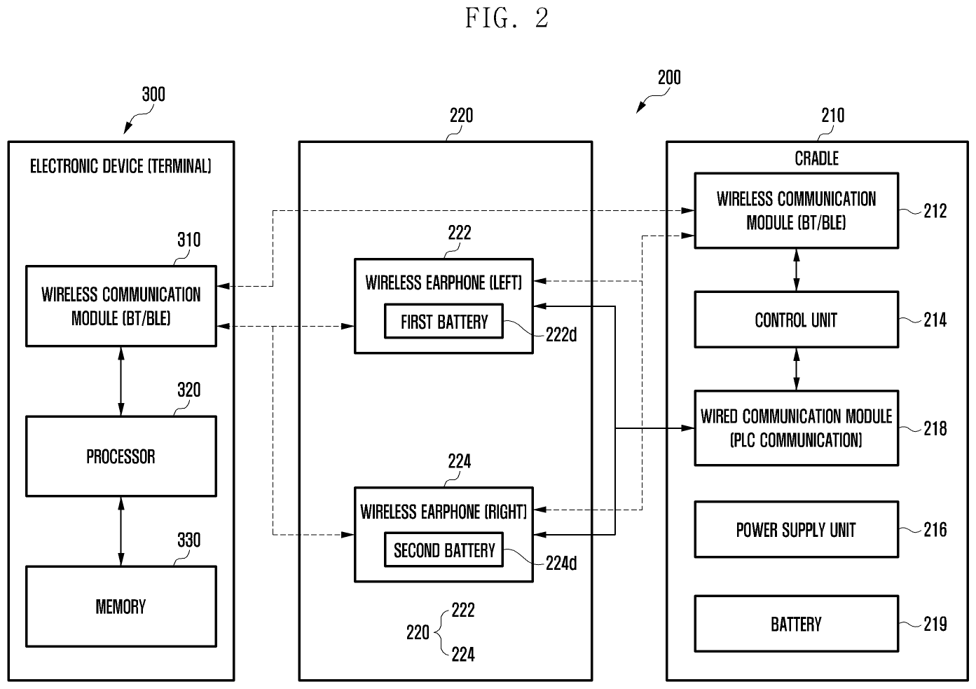

FIG. 2 is a diagram illustrating an electronic device including a wearable electronic device (e.g., a TWS wireless earphone) and a cradle according to an embodiment of the disclosure.

Referring to FIG. 2, according to one embodiment of the disclosure, an electronic device 300 (e.g., the electronic device 101 of FIG. 1, a smartphone, a smartwatch, a tablet personal computer (PC), or a notebook PC), a cradle 210, and a plurality of wireless earphones 220 (e.g., TWS wireless earphones, wireless earphone units) may be formed as an independent device.

According to one embodiment of the disclosure, an electronic device (e.g., a wearable electronic device) may comprise a cradle 210 (e.g., a case) (e.g., a charging device) and a plurality of wireless earphones 220 (e.g., TWS wireless earphones, wireless earphone units).

According to one embodiment of the disclosure, an electronic device 300 (e.g., the electronic device 101 of FIG. 1, a smartphone, a smart watch, a tablet PC, or a notebook PC) may include a wireless communication module 310 (e.g., the wireless communication module 192 of FIG. 1), the processor 320 (e.g., the processor 120 of FIG. 1), and the memory 330 (e.g., the memory 130 of FIG. 1)

According to one embodiment of the disclosure, the electronic device 300 may communicate with an external electronic device (e.g., a wearable electronic device) through a wireless communication module 310 in a Bluetooth and/or Bluetooth low energy (BLE) manner. For example, the external electronic device may include a plurality of wireless earphones 220 (e.g., TWS wireless earphones, wireless earphone units) and/or a cradle 210. For example, the electronic device 300 may communicate with a plurality of wireless earphones 220 (e.g., TWS wireless earphones, wireless earphone units) and/or a cradle 210.

According to one embodiment of the disclosure, the processor 320 may execute programs (e.g., application software for controlling wireless earphones) and/or instructions stored in the memory 330 to control the wireless communication module 310 and/or at least one other component (e.g., hardware or software component) of the electronic device 300 connected to the processor 320.

For example, the processor 320 may perform various data processing or operations, and may store instructions or data received from other components of the electronic device 300 (e.g., the sensor module 176, the wireless communication module 310) in the memory 330. The processor 320 may process the programs, data, and/or instructions stored in the memory 330, and may store the results of the processing in the memory 330.

According to one embodiment of the disclosure, the memory 330 may store programs and/or data for controlling the plurality of wireless earphones 220 (e.g., TWS wireless earphones, wireless earphone units). For example, the programs stored in the memory 330 may include application software (e.g., a wearable application) for controlling the wireless earphones. For example, the memory 330 may store a program for controlling the operation of the cradle 210 and/or a plurality of wireless earphones 220 (e.g., TWS wireless earphones, wireless earphone units). For example, the program may include instructions for controlling operation of the cradle 210 and/or the plurality of wireless earphones 220 (e.g., TWS wireless earphones, wireless earphone units).

According to one embodiment of the disclosure, the cradle 210 of the wearable electronic device may include a wireless communication module 212, a control unit 214 (e.g., a processor), a power supply unit 216, a wired communication module 218, and a battery 219.

For example, the wireless communication module 212 may support wireless communication between the cradle 210 and a plurality of wireless earphones 220 (e.g., TWS wireless earphones, wireless earphone units). For example, the control unit 214 may control the operation of the wireless communication module 212, the power supply unit 216, the wired communication module 218, and the plurality of wireless earphones 220 (e.g., TWS wireless earphones, wireless earphone units). For example, the power supply unit 216 may provide power to charge the battery 219 and/or the plurality of wireless earphones 220 (e.g., TWS wireless earphones, wireless earphone units). For example, the wired communication module 218 may support wired communication between the cradle 210 and the plurality of wireless earphones 220 (e.g., TWS wireless earphones, wireless earphone units).

According to one embodiment of the disclosure, the plurality of wireless earphones 220 (e.g., TWS wireless earphones, wireless earphone units) may be disposed on an inner space of the cradle 210. For example, when the plurality of wireless earphones 220 (e.g., TWS wireless earphones, wireless earphone units) are positioned inside the interior of the cradle 210, the cradle 210 may charge the plurality of wireless earphones 220 (e.g., TWS wireless earphones, wireless earphone units) and perform communication with the plurality of wireless earphones 220 (e.g., TWS wireless earphones, wireless earphone units).

According to one embodiment of the disclosure, the cradle 210 may include a wireless communication module 212, a control unit 214, a power supply unit 216, a wired communication module 218, a battery 219, and a power interface.

In some embodiments of the disclosure, the cradle 210 may include a coil for wireless charging. According to one embodiment of the disclosure, the cradle 210 may be operable to convert direct current (DC) power from a travel adapter (TA) or power supply to alternating current (AC) power and transmit the power to a plurality of wireless earphones 220 (e.g., TWS wireless earphones, wireless earphone units) through the power supply unit 216 when direct current (DC) power is supplied.

According to one embodiment of the disclosure, the cradle 210 and the plurality of wireless earphones 220 (e.g., TWS wireless earphones, wireless earphone units) may be in wired communication through a wired communication module 218. The cradle 210 and the plurality of wireless earphones 220 (e.g., TWS wireless earphones, wireless earphone units) may be in wireless communication (e.g., Bluetooth and/or Bluetooth low energy (BLE)) through a wireless communication module 212 (e.g., a Bluetooth communication module and/or a BLE communication module).

According to one embodiment of the disclosure, the cradle 210 and the electronic device 300 may communicate through Bluetooth or Bluetooth low energy (BLE). For example, when a first wireless earphone 222 and/or the second wireless earphone 224 are positioned outside of the cradle 210 (or when the cover of the cradle 210 (the cover of the housing) is opened), Bluetooth (or low power Bluetooth) communication of the first wireless earphone 222 and/or the second wireless earphone 224 may be enabled, and the first wireless earphone 222 and/or the second wireless earphone 224 may be paired with the electronic device 300 through Bluetooth communication.

According to one embodiment of the disclosure, the cradle 210 may be in Bluetooth and/or BLE communication with the electronic device 300 through the wireless communication module 212.

According to one embodiment of the disclosure, the electronic device 300 may control the operation of the cradle 210 using Bluetooth and/or BLE communication.

According to one embodiment of the disclosure, the control unit 214 of the cradle 210 may include a processor and memory storing instructions to enable the processor to perform operations.

For example, the processor of the control unit 214 may execute a program stored in the memory of the control unit 214 to control the wireless communication module 212, the power supply unit 216, and/or the wired communication module 218. In addition, the processor of the control unit 214 may control at least one other component (e.g., hardware or software component) of the cradle 210. For example, the processor of the control unit 214 may control the power supply unit 216 and the wired communication module 218 to communicate with the plurality of wireless earphones 220. According to one embodiment of the disclosure, two or more of the power supply unit 216, the wired communication module 218, and the control unit 214 may be integrated and configured as one.

For example, the memory of the control unit 214 may store programs and/or data for controlling the cradle 210 and/or the plurality of wireless earphones 220. For example, the memory of the control unit 214 may store instructions for controlling the operation of the cradle 210 and/or the plurality of wireless earphones 220.

According to one embodiment of the disclosure, the processor of the control unit 214 may communicate with the first wireless earphone 222 through the wired communication module 218.

According to one embodiment of the disclosure, the processor of the control unit 214 may communicate with the second wireless earphone 224 through the wired communication module 218.

According to one embodiment of the disclosure, the cradle 210 may activate the wireless communication module 212 when the first wireless earphone 222 and the second wireless earphone 224 are woken up.

According to one embodiment of the disclosure, the electronic device 300 may perform a connection operation with the first wireless earphone 222 and/or the second wireless earphone 224 using the wireless communication module 310 after the first wireless earphone 222 and/or the second wireless earphone 224 are woken up.

According to one embodiment of the disclosure, the electronic device 300 may perform a connection operation with the first wireless earphone 222 and/or the second wireless earphone 224 using the wireless communication module 212 after the first wireless earphone 222 and/or the second wireless earphone 224 are woken up.

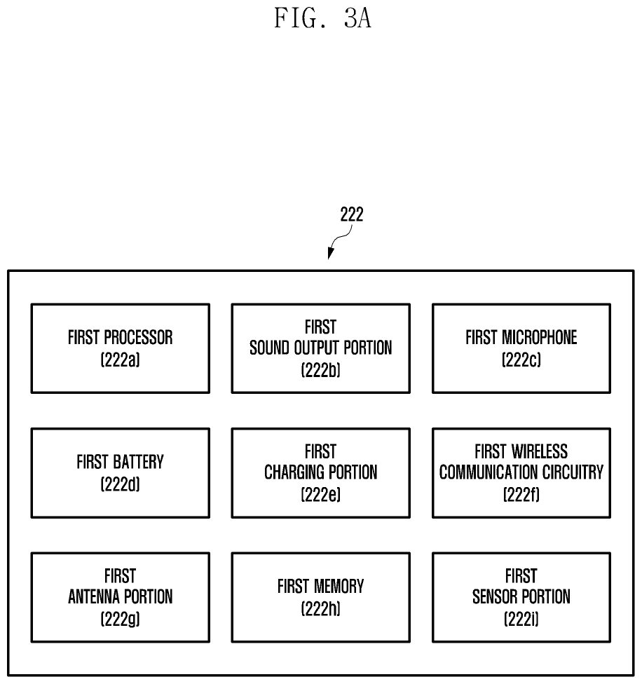

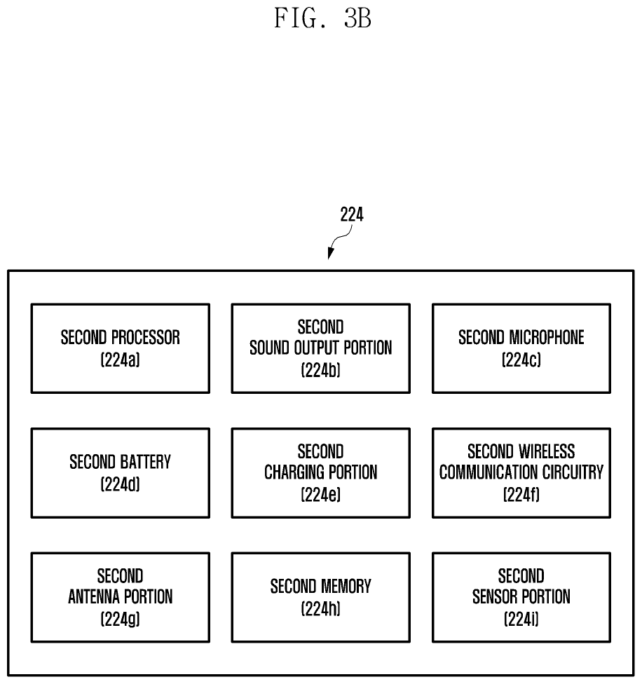

FIG. 3A is a block diagram of a wearable electronic device (e.g., a TWS wireless earphone, a first wireless earphone unit, a left wireless earphone unit) according to an embodiment of the disclosure. FIG. 3B is a block diagram of a wearable electronic device (e.g., a TWS wireless earphone, a second wireless earphone unit, a right wireless earphone unit) according to an embodiment of the disclosure.

Referring to FIGS. 2, 3A, and 3B, a cradle 210 (e.g., a case) (e.g., a charging device) and a plurality of wireless earphones 220 (e.g., TWS wireless earphones, wireless earphone units) may comprise an electronic device (e.g., a wearable electronic device).

An electronic device (e.g., a wearable electronic device) according to an embodiment of the disclosure may include a cradle 210 (e.g., a case) (e.g., a charging device) and a plurality of wireless earphones 220 (e.g., TWS wireless earphones, wireless earphone units). According to one embodiment of the disclosure, the first wireless earphone 222 and the second wireless earphone 224 may be formed as a set of two, and may each include corresponding components. The first wireless earphone 222 and the second wireless earphone 224 may have all or a portion of the same components, and the components corresponding to each other may be described collectively.

FIG. 3A illustrates a first wireless earphone 222 (e.g., a TWS wireless earphone, a first wireless earphone unit, a left wireless earphone unit) among a plurality of wireless earphones 220 (e.g., TWS wireless earphones, wireless earphone units).

According to one embodiment of the disclosure, the cradle 210 may operate in conjunction with a plurality of wireless earphones 220 and an electronic device (e.g., the electronic device 101 of FIG. 1, the electronic device 300 of FIG. 2, a terminal).

According to one embodiment of the disclosure, the plurality of wireless earphones 220 may operate in conjunction with the electronic devices 101 and 300.

In one embodiment of the disclosure, at least one of the plurality of wireless earphones 220 may be operable in conjunction with the cradle 210 and an external electronic device 101 and 300, or terminal. In other examples, at least one of the plurality of wireless earphones 220 may operate in conjunction with an external electronic device 101 and 300 (a terminal) independent of the cradle 210. In another example, at least one of the plurality of wireless earphones 220 may operate in conjunction with the cradle 210 independently of the external electronic device 101 and 300 (a terminal).

According to one embodiment of the disclosure, a first wireless earphone 222 (e.g., a TWS wireless earphone, a first wireless earphone unit, a left wireless earphone unit) may include a first processor 222a, a first sound output portion 222b (e.g., speaker/receiver), a first microphone 222c, a first battery 222d, a first charging portion 222e, a first wireless communication circuitry 222f (e.g., a wireless communication circuitry), a first antenna portion 222g, first memory 222h, and/or a first sensor portion 222i (e.g., a wearable sensor, a biometric sensor, a gyro sensor, a geomagnetic sensor, a GPS sensor, a body temperature sensor, a moisture sensor, a barometric pressure sensor, and/or a touch sensor).

According to one embodiment of the disclosure, the second wireless earphone 224 (e.g., a TWS wireless earphone, a second wireless earphone unit, a right wireless earphone unit) may include a second processor 224a, a second sound output portion 224b (e.g., speaker/receiver), a second microphone 224c, a second battery 224d, a second charging portion 224e, a second wireless communication circuitry 224f (e.g., a wireless communication circuitry), a second antenna portion 224g, second memory 224h, and/or a second sensor portion 224i (e.g., a wearable sensor, a biometric sensor, a gyro sensor, a geomagnetic sensor, a GPS sensor, a body temperature sensor, a moisture sensor, a barometric pressure sensor, and/or a touch sensor).

According to one embodiment of the disclosure, the first processor 222a and/or the second processor 224a may control operation of the first wireless earphone 222 and/or the second wireless earphone 224. In one example, the first processor 222a and/or the second processor 224a may include a processing circuitry or a control circuit, such as a micro controller unit (MCU), a central processing unit (CPU), a sensor processor, a sensor hub, an application processor (AP), and/or a communication processor (CP). For example, the first processor 222a and/or the second processor 224a may control components included in the electronic devices 101 and 300 or cradle 210 (e.g., the cradle 210 of FIG. 2) and perform various data processing or computations.

In one embodiment of the disclosure, the first processor 222a and/or the second processor 224a may determine a wearing state of the first wireless earphone 222 and/or the second wireless earphone 224 based on sensor data (or sensing information) (e.g., proximity information, posture information, and/or touch information) acquired from the sensor circuitry (e.g., the first sensor portion 222i and/or the second sensor portion 224i).

In one embodiment of the disclosure, the first processor 222a and/or the second processor 224a may change an operation mode of the first wireless earphone 222 and/or the second wireless earphone 224 based on sensor data (or sensing information) acquired from the sensor circuitry (e.g., the first sensor portion 222i and/or the second sensor portion 224i) and control communication with the electronic device 101 and 300 (a terminal).

In one embodiment of the disclosure, the first processor 222a and/or the second processor 224a may control the electronic device 101 and 300 to execute an application (e.g., a music player) stored in the memory 130 and 330 of the electronic device 101 and 300, play audio/video data stored in the memory, and output sound.

In one embodiment of the disclosure, the first processor 222a and/or the second processor 224a may seamlessly control the cooperative operation with the cradle 210 and/or external electronic devices 101 and 300) based on a wearing state of the first wireless earphone 222 and/or the second wireless earphone 224, and a charging state of the first battery 222d of the first wireless earphone 222 and/or the second battery 224d of the second wireless earphone 224.

In one embodiment of the disclosure, the first wireless earphone 222 and the second wireless earphone 224 may include a speaker. For example, the first wireless earphone 222 and/or the second wireless earphone 224 may output audio signals (e.g., sound) through the speakers of the first sound output portion 222b and/or the second sound output portion 224b.

According to one embodiment of the disclosure, the first sound output portion 222b and/or the second sound output portion 224b may output a sound signal (or audio signal) received from an external electronic device 101 and 300, or a sound signal (or audio signal) received from the cradle 210 to an external source (e.g., a user's ear).

According to one embodiment of the disclosure, the first sound output portion 222b or the second sound output portion 224b may output a sound signal executed by the first wireless earphone 222 or the second wireless earphone 224 to an external source (e.g., the user's ear).

In one embodiment of the disclosure, the first sound output portion 222b and/or the second sound output portion 224b may output audio data received from a wireless communication module of the electronic device 101 and 300 (e.g., the wireless communication module 192 of FIG. 1, the wireless communication module 310 of FIG. 2) to an external source (e.g., a user's ear). For example, the first sound output portion 222b or the second sound output portion 224b may output audio data stored in memory of the electronic device 101 and 300 (e.g., the memory 130 of FIG. 1, the memory 330 of FIG. 2) to an external source (e.g., a user's ear). For example, the first sound output portion 222b or the second sound output portion 224b may output audio data stored in the first memory 222h or the second memory 224h to an external source (e.g., a user's ear).

In some embodiments of the disclosure, the first sound output portion 222b and/or the second sound output portion 224b may output sound signals associated with various actions (or functions) performed by the electronic devices 101 and 300.

In one embodiment of the disclosure, the first wireless earphone 222 may include a first microphone 222c. The second wireless earphone 224 may include a second microphone 224c. For example, the first wireless earphone 222 and/or the second wireless earphone 224 may receive (or input) audio signals (e.g., sound) from an external source through the first microphone 222c and/or the second microphone 224c.

According to one embodiment of the disclosure, the first microphone 222c and/or the second microphone 224c may receive (or acquire) an audio signal (e.g., sound) from an external source (e.g., a user). The first microphone 222c and/or the second microphone 224c may receive the external sound signal and process it into electrical voice data. For example, the first microphone 222c and/or the second microphone 224c may implement various noise reduction algorithms to remove noise generated during the process of receiving the external sound signal as input.

The first charging portion 222e and/or the second charging portion 224e, according to one embodiment of the disclosure, may be controlled by the first processor 222a and/or the second processor 224a to receive an external power source and/or an internal power source to provide power required for operation of the respective components, and may charge the first battery 222d and/or the second battery 224d. For example, the first charging portion 222e and/or the second charging portion 224e may power on or off the first wireless communication circuitry 222f and/or the second wireless communication circuitry 224f under control of the first processor 222a and/or the second processor 224a. For example, the first charging portion 222e and/or the second charging portion 224e may power on or off the first sensor portion 222i and/or the second sensor portion 224i by control of the first processor 222a and/or the second processor 224a.

In one embodiment of the disclosure, the first charging portion 222e and the second charging portion 224e may include a power management integrated circuit (PMIC). In one embodiment of the disclosure, the first charging portion 222e and the second charging portion 224e may include battery controlling/processing circuitry, a charger IC, and/or step-up circuitry to control charging of the first battery 222d and/or the second battery 224d.

In one embodiment of the disclosure, the first battery 222d and/or the second battery 224d may include a non-rechargeable primary cell, a rechargeable secondary cell, or a fuel cell.

In one embodiment of the disclosure, the first wireless communication circuitry 222f of the first wireless earphone 222 and/or the second wireless communication circuitry 224f of the second wireless earphone 224 may include the same or similar configurations as the wireless communication module 192 of FIG. 1. For example, the first wireless communication circuitry 222f and the second wireless communication circuitry 224f may establish a wireless communication channel with each other and perform communications using the established communication channel. For example, the first wireless communication circuitry 222f and/or the second wireless communication circuitry 224f may include one or more communication circuitry to enable wireless communication between the cradle 210 (e.g., the cradle 210 of FIG. 2). For example, the first wireless communication circuitry 222f and/or the second wireless communication circuitry 224f may establish a wireless communication channel with the external electronic devices 101 and 300 and perform communications using the established communication channel.

In one embodiment of the disclosure, the first wireless communication circuitry 222f and the second wireless communication circuitry 224f may be connected to each other using Bluetooth, Bluetooth low energy (BLE), Wi-Fi, adaptive network topology (ANT+), long term evolution (LTE), fifth generation mobile telecommunication (5G), and/or narrowband internet of things (NB-IoT).

In one embodiment of the disclosure, the first wireless communication circuitry 222f and the second wireless communication circuitry 224f may be connected to an external electronic device 101 and 300 using Bluetooth, Bluetooth low energy (BLE), Wi-Fi, ANT+, LTE, 5G, and/or NB-IoT.

In some embodiments of the disclosure, the first wireless communication circuitry 222f and the second wireless communication circuitry 224f may be connected to an access point (AP), or other network using Bluetooth, Bluetooth low energy (BLE), Wi-Fi, ANT+, LTE, 5G, and/or NB-IoT.

In one embodiment of the disclosure, the first wireless communication circuitry 222f and/or the second wireless communication circuitry 224f may be interfaced with external devices 101 and 300 or each other that are connected (e.g., paired) through a designated network (e.g., a local area network) to transmit or receive various data through the first antenna portion 222g and the second antenna. According to one embodiment of the disclosure, the first wireless communication circuitry 222f or the second wireless communication circuitry 224f may remain on at all times, or may be turned on or turned off based on a preconfigured operation or user input.

According to one embodiment of the disclosure, the first antenna portion 222g and/or the second antenna portion 224g may transmit signals or power to each other and/or to an external electronic device 101 and 300, or receive power from an external source.

In one embodiment of the disclosure, the first antenna portion 222g and/or the second antenna portion 224g may include one or more antennas including a conductor formed on a substrate (e.g., PCB) or a radiator including a conductive pattern. In some embodiments of the disclosure, other components (e.g., RFICs) in addition to the radiator may additionally be formed as part of the first antenna portion 222g (or the second antenna).

According to one embodiment of the disclosure, the first sensor portion 222i or the second sensor portion 224i may include touch circuits (or touch sensors) disposed on a portion of the substrate inside the touch pad to detect a user's touch (or touch signal).

According to one embodiment of the disclosure, the first memory 222h and/or the second memory 224h may store one or more programs (or applications) and instructions executed by a processor of the external electronic device 101 and 300 (e.g., the processor 120 of FIG. 1, the processor 320 of FIGS. 3A and 3B), and may temporarily and/or transiently store data input to and/or output from the electronic device 101 and 300. The data input to and/or output from the electronic devices 101 and 300 may include, for example, audio streaming, voice commands, mode configurations, and/or status information. According to one embodiment of the disclosure, the first memory 222h and/or the second memory 224h may store data acquired in real time on a transient storage device and data that is determined to be stored on a long-term storage device.

According to one embodiment of the disclosure, the first sensor portion 222i and/or the second sensor portion 224i may be the same or similar to the sensor module 176 of FIG. 1. According to one embodiment of the disclosure, the first sensor portion 222i and/or the second sensor portion 224i may include at least one sensor (e.g., an inertial sensor (e.g., an accelerometer, a geomagnetic sensor, a gyro sensor)) capable of detecting a movement, an impact magnitude, and/or a position of the electronic devices 101 and 300 and generating data used to determine the movement, the impact magnitude, and/or the position.

In one embodiment of the disclosure, the first sensor portion 222i (or the second sensor portion 224i) may include at least one sensor (e.g., a wear detection sensor) capable of detecting whether the first wireless earphone 222 (or the second wireless earphone 224) is worn on a user's body and generating data used to determine wear or non-wear.

According to one embodiment of the disclosure, sensing data (or sensing information) based on sensing results from the first sensor portion 222i and/or the second sensor portion 224i may be provided to the processors 120 and 320 of the electronic devices 101 and 300.

According to one embodiment of the disclosure, the first sensor portion 222i and/or the second sensor portion 224i may include a touch circuit (or a touch sensor) to detect a touch (or a touch signal). For example, the touch circuit may include a capacitive touch sensor or a pressure sensitive touch sensor, and may detect a single touch, a multi touch, a surface touch, and/or a palm touch.

In various embodiments of the disclosure, the first wireless earphone 222 and/or the second wireless earphone 224 may be in communication with an external electronic device 101 and 300 (e.g., a smartphone and/or a tablet PC).

According to one embodiment of the disclosure, the external electronic device 101 and 300 may be connected to a wireless earphone that operates as a central (or, a primary, or a main) among the first wireless earphone 222 and/or the second wireless earphone 224.

In one embodiment of the disclosure, the external electronic devices 101 and 300 may be connected to the cradle 210.

In one embodiment of the disclosure, the external electronic devices 101 and 300 may be connected to each of the first wireless earphone 222 and the second wireless earphone 224 based on a multi connection. For example, the first wireless earphone 222 and the second wireless earphone 224 may be paired wirelessly (e.g., RF, BT, or BLE) with the external electronic devices 101 and 300. For example, the first wireless earphone 222 and the second wireless earphone 224 may receive audio signals associated with a function executed on the connected external electronic device 101 and 300 (e.g., playing music, receiving a phone call, an alarm, or receiving sound through a microphone of the external electronic device 101 and 300), convert the audio signals to sound, and output the audio signals to the outside.

In one embodiment of the disclosure, configurations and operational states of the first wireless earphone 222 and the second wireless earphone 224 may be changed through the external electronic device 101 and 300. For example, the volume of the first wireless earphone 222 and the second wireless earphone 224 may be adjusted through the external electronic device 101 and 300. In some embodiments of the disclosure, the first wireless earphone 222 and the second wireless earphone 224 may also be configured to an operating mode through various sensors (e.g., acceleration sensors, gyro sensors, biometric sensors, and/or proximity sensors).

A general in-ear type earphone unit may have an antenna pattern formed only on the antenna carrier. For example, a general in-ear type earphone unit may electrically connect an antenna drive circuit disposed on a printed board assembly (PCB) with an antenna pattern formed on an antenna carrier (e.g., a laser direct structuring (LDS) pattern) using a contact structure (e.g., a C-clip). Since the antenna pattern is formed only on the antenna carrier, there is a limitation in forming the antenna pattern length and the shape of the antenna pattern for 2.4 GHZ (other bands are also possible).

As the functions of wearable electronic devices (e.g., TWS wireless earphones) become more sophisticated, multiple electronic components are disposed on a limited space, and the antenna pattern is disposed on the antenna carrier, which may result in a small area of the antenna pattern and lower antenna performance.

When wearing an in-ear type earphone unit of a general wearable electronic device, the distance between the user's body and the antenna pattern is close, and the antenna performance may be reduced because of noise. In the case that conformal metal shielding is applied to eliminate noise, the radio frequency (RF) performance of the wearable electronic device (e.g., the TWS wireless earphone) may be reduced.

When a semiconductor packaging substrate (e.g., a SiP substrate) is applied to the wearable electronic device (e.g., the TWS wireless earphone), the RF port of the main IC (integrated circuit) and the antenna area may be separated by a long distance, which may cause path loss.

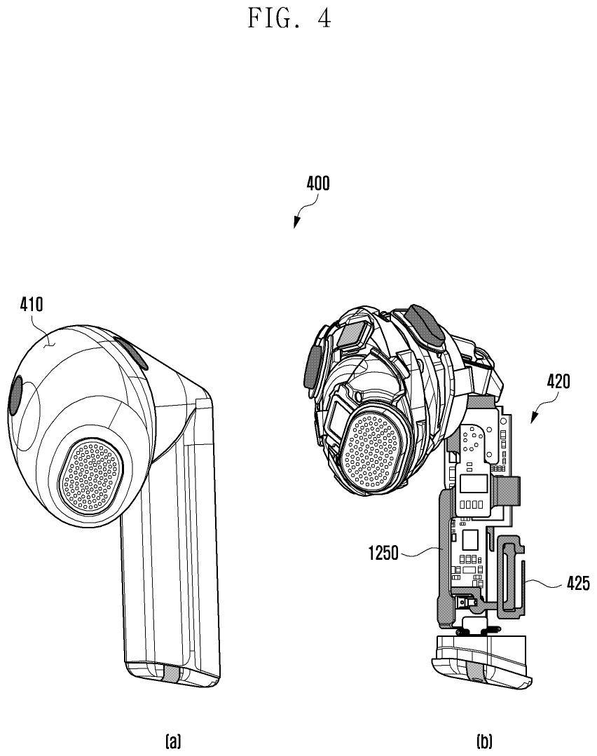

FIGS. 4 to 6 are diagrams illustrating a wearable electronic device (e.g., a TWS wireless earphone, a wireless earphone unit) according to various embodiments of the disclosure.

FIG. 4 is a front view of a wearable electronic device 400 (e.g., a TWS wireless earphone, a wireless earphone unit) according to an embodiment of the disclosure.

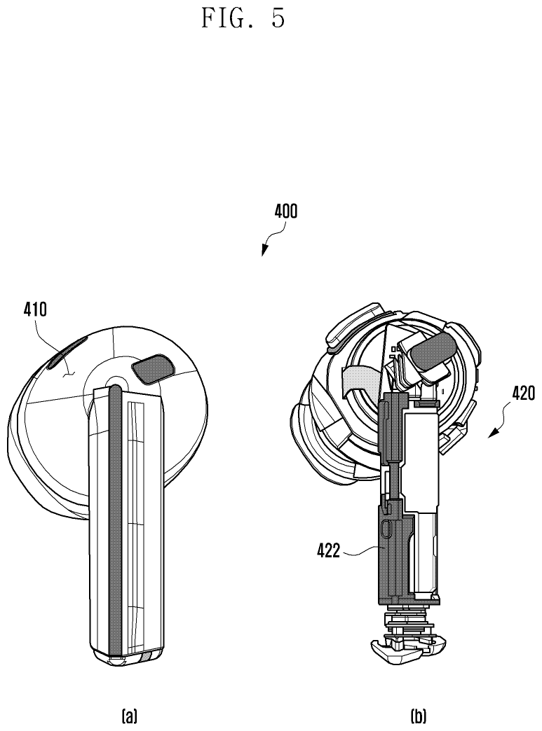

FIG. 5 is a rear view of a wearable electronic device 400 (e.g., a TWS wireless earphone, a wireless earphone unit) according to an embodiment of the disclosure.

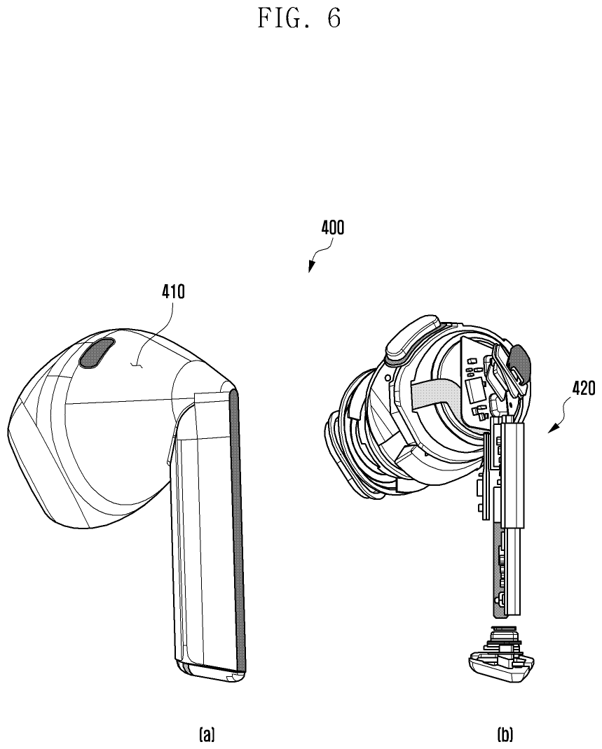

FIG. 6 is a side view of a wearable electronic device 400 (e.g., a TWS wireless earphone, a wireless earphone unit) according to an embodiment of the disclosure.

Referring to part (a) in FIGS. 4 to 6, it illustrates an outer case 410 disposed on a wearable electronic device 400 (e.g., a TWS wireless earphone, a wireless earphone unit), according to various embodiments of the disclosure. Referring to part (b) in FIGS. 4 to 6, it illustrates the wearable electronic device 400 (e.g., the TWS wireless earphone, the wireless earphone unit) with the outer case 410 removed to reveal the internal component portion 420.

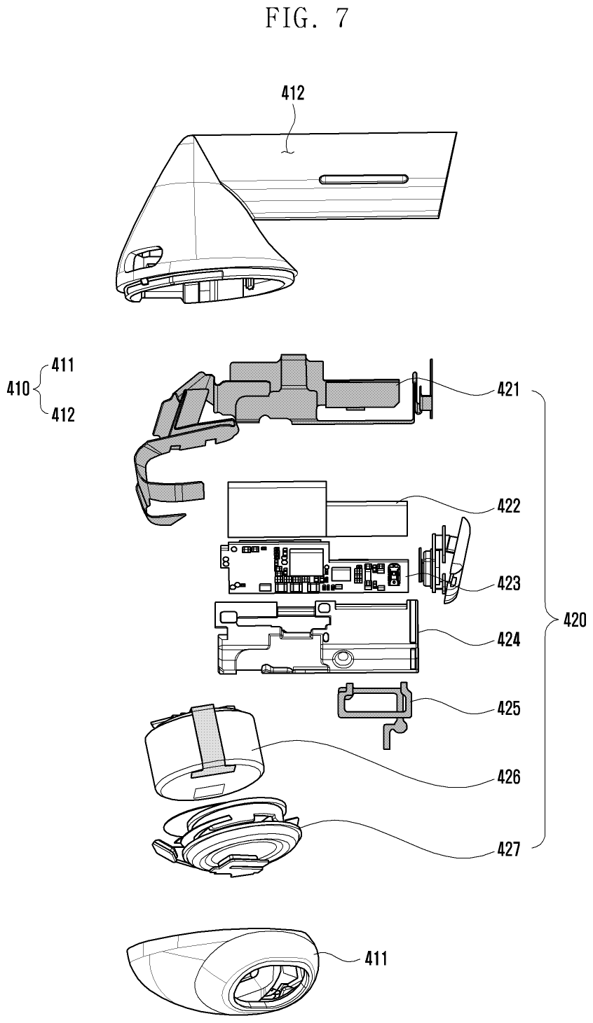

FIG. 7 is an exploded perspective view of a wearable electronic device (e.g., a TWS wireless earphone, a wireless earphone unit) according to an embodiment of the disclosure.

Referring to FIGS. 4 to 7, a wearable electronic device 400 (e.g., a TWS wireless earphone, a wireless earphone unit) according to various embodiments of the disclosure may include an outer case 410 and an internal component portion 420. For example, the internal component portion 420 may be disposed on an inner space formed by the outer case 410.

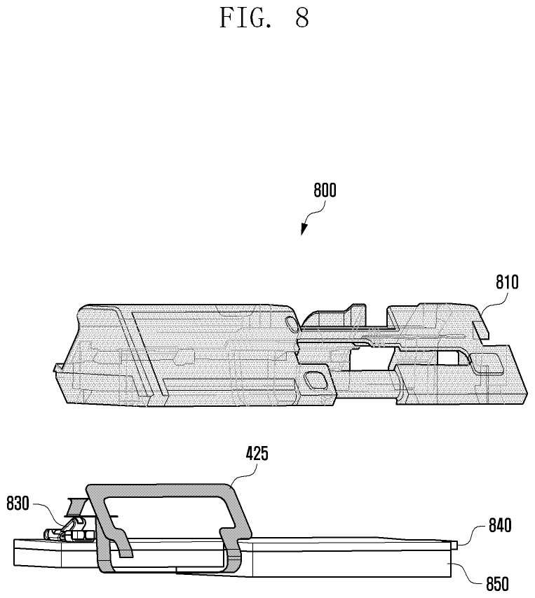

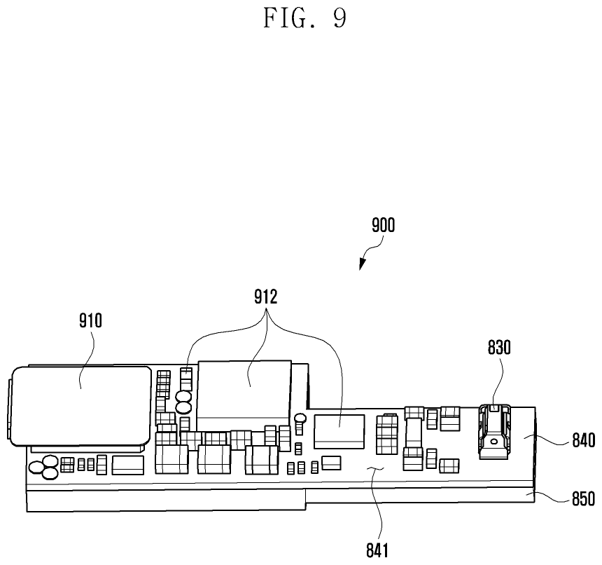

According to an embodiment of the disclosure, the outer case 410 may include a rear case 411, and a front case 412 (e.g., a stem part case). For example, the internal component portion 420 may include a speaker 427, a battery 426, an antenna pattern 425, an antenna carrier 424, a flexible printed circuit board 421 (FPCB), a printed circuit board 423 (PCB) (e.g., a printed circuit board 840 of FIGS. 8 and 9), and a semiconductor packaging substrate 422 (a SiP (system in package) substrate) (e.g., a semiconductor packaging substrate 850 of FIGS. 8 and 9).

According to an embodiment of the disclosure, the semiconductor packaging substrate 422 and 850 (e.g., the system in package (SiP) substrate) may be applied to the wearable electronic device 400 (e.g., the TWS wireless earphone) in order to dispose various electronic components within a limited inner space of the wearable electronic device 400 (e.g., the TWS wireless earphone).

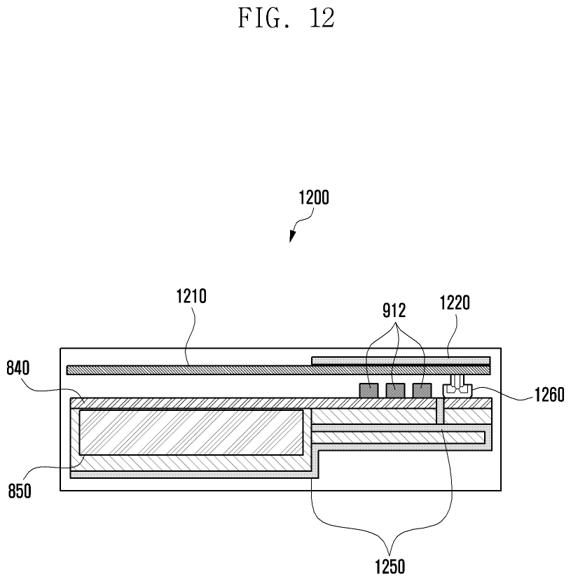

For example, the wearable electronic device 400 (e.g., the TWS wireless earphone, the wireless earphone unit) according to an embodiment of the disclosure may include an antenna structure (e.g., an antenna pattern). For example, the antenna structures (e.g., antenna patterns) may include a first antenna structure 425 (a first antenna pattern) (e.g., the first antenna structure 1220 of FIG. 12), and a second antenna structure 1250 (a second antenna pattern) (e.g., the second antenna structure 1250 of FIG. 12). The first antenna structure 425 and 1220 (the first antenna pattern) may be disposed on at least a portion of the antenna carrier 424. The second antenna structure 1250 (the second antenna pattern) may be disposed on at least a portion of the semiconductor packaging substrate 422 and 850 (e.g., a SiP substrate).

For example, a printed circuit board 423 (PCB) may be packaged with and electrically connected to the semiconductor packaging substrate 422 (SiP). For example, the flexible printed circuit board 421 (FPCB) may be electrically connected to the printed circuit board 423 (PCB) and the semiconductor packaging substrate 422 (SiP).

For example, the first antenna structure 425 and 1220 (the first antenna pattern) may be electrically coupled to at least one of the flexible printed circuit board 421 (FPCB), printed circuit board 423 (PCB), and semiconductor packaging substrate 422 (SiP). For example, the second antenna structure 1250 (the second antenna pattern) may be electrically coupled to at least one of the flexible printed circuit board 421 (FPCB), the printed circuit board 423 (PCB), and the semiconductor packaging substrate 422 (SiP).

The radio frequency (RF) functionality of the wearable electronic device 400 (e.g., the TWS wireless earphones) according to an embodiment of the disclosure may be provided through a radio frequency (RF) port of a main integrated circuit (main IC) disposed on the printed circuit board 423 (PCB). The wearable electronic device (e.g., the TWS wireless earphone) may provide antenna functionality including a filter, matching, switch, contact structure (e.g., C-clip), a first antenna structure 425 and 1220 (a first antenna pattern), and a second antenna structure 1250 (a second antenna pattern).

FIG. 8 is a diagram 800 illustrating an antenna carrier disposed on a stem part of a wearable electronic device (e.g., a TWS wireless earphone, a wireless earphone unit) and a first antenna structure (e.g., a first antenna pattern) disposed on the antenna carrier according to an embodiment of the disclosure.

Referring to FIGS. 4 to 8, a wearable electronic device 400 (e.g., a TWS wireless earphone) according to various embodiments of the disclosure may have an earphone unit formed as a stem type. For example, the wearable electronic device 400 (e.g., the TWS wireless earphone) according to an embodiment of the disclosure may include an antenna carrier 810, a first antenna structure 425 (a first antenna pattern), a contact structure 830 (C-clip), a printed circuit board 840, and a semiconductor packaging substrate 850 (a SiP substrate). For example, the contact structure 830 may include various contact structures (e.g., contact patterns) other than the C-clip.

For example, the antenna carrier 810 may be disposed on a stem portion of the wearable electronic device 400 (e.g., the TWS wireless earphone). A first antenna structure 425 (a first antenna pattern) (e.g., the first antenna structure 1220 of FIG. 12) may be disposed on at least a portion of the antenna carrier 810 of the wearable electronic device 400 (e.g., the TWS wireless earphone).

For example, a semiconductor packaging substrate 850 (a SiP substrate) may be disposed on a stem portion of the wearable electronic device 400 (e.g., the TWS wireless earphone). A second antenna structure (e.g., the second antenna structure 1250 of FIG. 12) may be disposed on at least a portion of the semiconductor packaging substrate 850 (the SiP substrate).

The wearable electronic device 400 (e.g., the TWS wireless earphone) according to an embodiment of the disclosure may have a first antenna structure 425 (e.g., a first antenna pattern) (e.g., the first antenna structure 1220 of FIG. 12) and a second antenna structure (e.g., the second antenna structure 1250 of FIG. 12) disposed on the stem portion, such that the separation distance (e.g., the spacing) between the user's human body and the antenna structures 1220 and 1250 (e.g., the antenna pattern) may be relatively increased compared to an in-ear type. By increasing the separation distance (e.g., the spacing) between the user's body and the antenna structures 1220 and 1250 (the antenna patterns), noise may be reduced, and antenna performance may be improved.

By forming the antenna structures 1220 and 1250 (the antenna patterns) to be noise-resistant, the wearable electronic device 400 (e.g., the TWS wireless earphone) according to an embodiment of the disclosure may reduce noise and improve antenna performance without the need for conformal metal shielding, which is often applied to in-ear type wireless earphones.

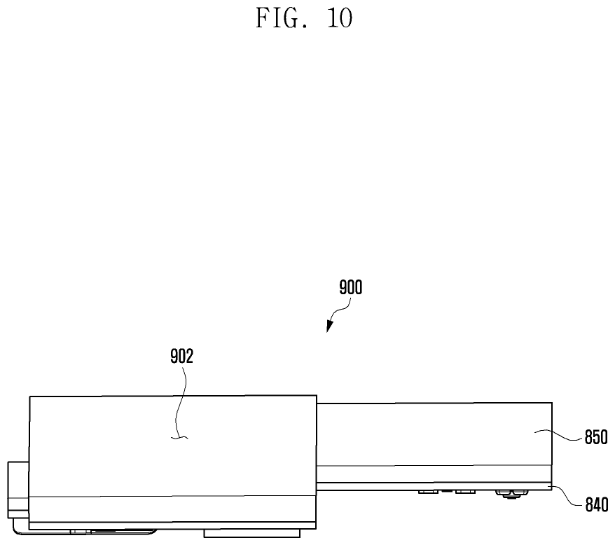

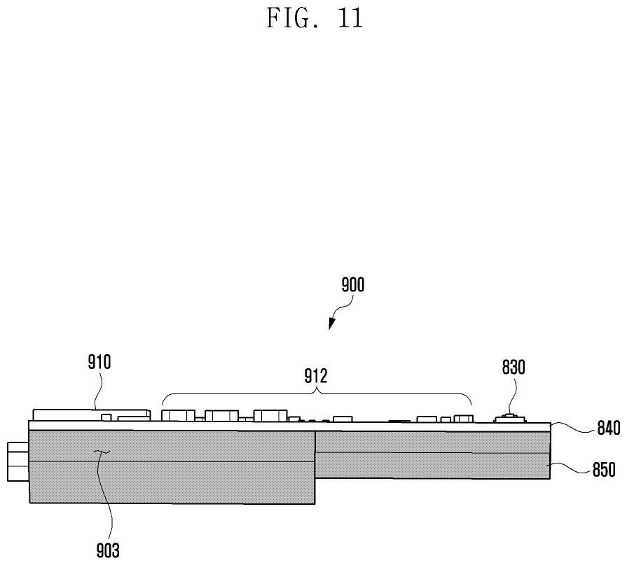

FIG. 9 is a diagram illustrating a printed circuit board and a semiconductor packaging substrate (e.g., a SiP substrate) and illustrating electronic components disposed on a first surface (e.g., a front surface) of the printed circuit board according to an embodiment of the disclosure. FIG. 10 is a diagram illustrating a printed circuit board and a semiconductor packaging substrate (e.g., a SiP substrate) and illustrating a second surface (e.g., a rear surface) of a semiconductor packaging substrate (e.g., a SiP substrate) according to an embodiment of the disclosure. FIG. 11 is a diagram illustrating a printed circuit board and a semiconductor packaging substrate (e.g., a SiP substrate) and illustrating a third surface (e.g., a side surface) of a semiconductor packaging substrate (e.g., a SiP substrate) according to an embodiment of the disclosure.

Referring to FIGS. 8 to 11, according to various embodiments of the disclosure, an interposer substrate 910, electronic components 912, and contact structure 830 (C-clip) may be disposed on a first surface 841 (e.g., a front surface) of printed circuit board 840. For example, the interposer substrate 910 may be utilized to electrically connect other electronic components (e.g., touch sensor circuitry) of a wearable electronic device (e.g., the wearable electronic device 400 of FIG. 4, a TWS wireless earphone) with the printed circuit board 840. For example, the electronic components 912 may include a control circuitry (e.g., a processor), memory, a six-axis sensor, and a power circuitry.

According to one embodiment of the disclosure, the semiconductor packaging substrate 850 (the SiP substrate) may include a first surface (e.g., a front surface), a second surface 902 (e.g., a rear surface), and a third surface 903 (e.g., a side surface). The second surface 902 (e.g., the rear surface) may be disposed on an opposite side of the first surface (e.g., the front surface). The third surface 903 (e.g., the side surface) may be disposed between the first surface (e.g., the front surface) and the second surface (e.g., the rear surface). FIG. 12 is a diagram 1200 illustrating a wearable electronic device according to an embodiment of the disclosure, wherein a first antenna structure is disposed on an antenna carrier and an antenna structure is disposed on a semiconductor packaging substrate (e.g., a SiP substrate).

Referring to FIG. 12, according to an embodiment of the disclosure, a first antenna structure 1220 (a first antenna pattern) (e.g., the antenna structure 425 of FIG. 8) may be disposed on at least a portion of an antenna carrier 1210 (e.g., the antenna carrier 810 of FIG. 8) using a contact structure 830 (C-clip). A second antenna structure 1250 (a second antenna pattern) may be disposed on at least a portion of the semiconductor packaging substrate 850 (the SiP substrate). For example, the first antenna structure 1220 (the first antenna pattern) and the second antenna structure 1250 (the second antenna pattern) may be electrically connected by a contact structure 1260.

Referring to FIGS. 9 to 12, the semiconductor packaging substrate 850 (the SiP substrate) may include a first surface (e.g., a front surface), a second surface 902 (e.g., a rear surface), and a third surface 903 (e.g., a side surface). The second surface 902 (e.g., the rear surface) may be disposed on an opposite side of the first surface (e.g., the front surface). The third surface 903 (e.g., the side surface) may be disposed between the first surface (e.g., the front surface) and the second surface (e.g., the rear surface).

For example, the first surface (e.g., the front surface) of the semiconductor packaging substrate 850 (the SiP substrate) may be disposed to be in contact with the second surface (e.g., the rear surface) of the printed circuit board 840. The first surface (e.g., the front surface) of the semiconductor packaging substrate 850 (the SiP substrate) and the second surface (e.g., the rear surface) of the printed circuit board 840 may be bonded by an adhesive material.

According to one embodiment of the disclosure, a second antenna structure (e.g., the second antenna structure 1250 of FIG. 12) may be disposed on at least one of a second surface 902 (e.g., a rear surface) and a third surface 903 (e.g., a side surface) of the semiconductor packaging substrate 850 (e.g., a SiP substrate).

For example, the second antenna structure 1250 (e.g., the second antenna pattern) may be disposed on all or a portion of the second surface 902 (e.g., the rear surface) of the semiconductor packaging substrate 850 (e.g., the SiP substrate).

For example, the second antenna structure 1250 (e.g., the second antenna pattern) may be disposed on all or a portion of the third surface 903 (e.g., the side surface) of the semiconductor packaging substrate 850 (e.g., a SiP substrate).

For example, the second antenna structure 1250 (e.g., the second antenna pattern) may be disposed on at least a portion of the second surface 902 (e.g., the rear surface) and the third surface 903 (e.g., the side surface) of the semiconductor packaging substrate 850 (e.g., a SiP substrate). For example, the dielectric constant of the molding material of the semiconductor packaging substrate 850 (e.g., a SiP substrate) may not affect the antenna performance. In a conformal coating method, the second antenna structure 1250 (e.g., the second antenna pattern) may be formed on at least a portion of the second surface 902 (e.g., the rear surface) and the third surface 903 (e.g., the side surface) of the semiconductor packaging substrate 850 (e.g., a SiP substrate).

For example, forming the second antenna structure 1250 (e.g., the second antenna pattern) on at least one of the second surface 902 (e.g., the rear surface) and the third surface 903 (e.g., the side surface) of the semiconductor packaging substrate 850 (e.g., a SiP substrate) may increase the antenna area by about 100 mm².

The wearable electronic device (e.g., the wearable electronic device 400 of FIG. 4, the TWS wireless earphone) according to an embodiment of the disclosure may have the second antenna structure 1250 (e.g., the second antenna pattern) disposed on at least a portion of the second surface 902 (e.g., the rear surface) and/or the third surface 903 (e.g., the side surface) of the semiconductor packaging substrate 850 (the SiP substrate) to increase the area of the overall antenna pattern of the wearable electronic device 400, thereby improving antenna performance.

The antenna pattern may be fill-cut in the antenna area to maximize radiation effectiveness. A wearable electronic device according to an embodiment of the disclosure (e.g., the wearable electronic device 400 of FIG. 4) may not need to apply metal shielding, so that noise generated by electronic components (e.g., the main IC) disposed on the semiconductor packaging substrate 850 (the SiP substrate) and printed circuit board 840 (PCB) does not affect the antenna area.

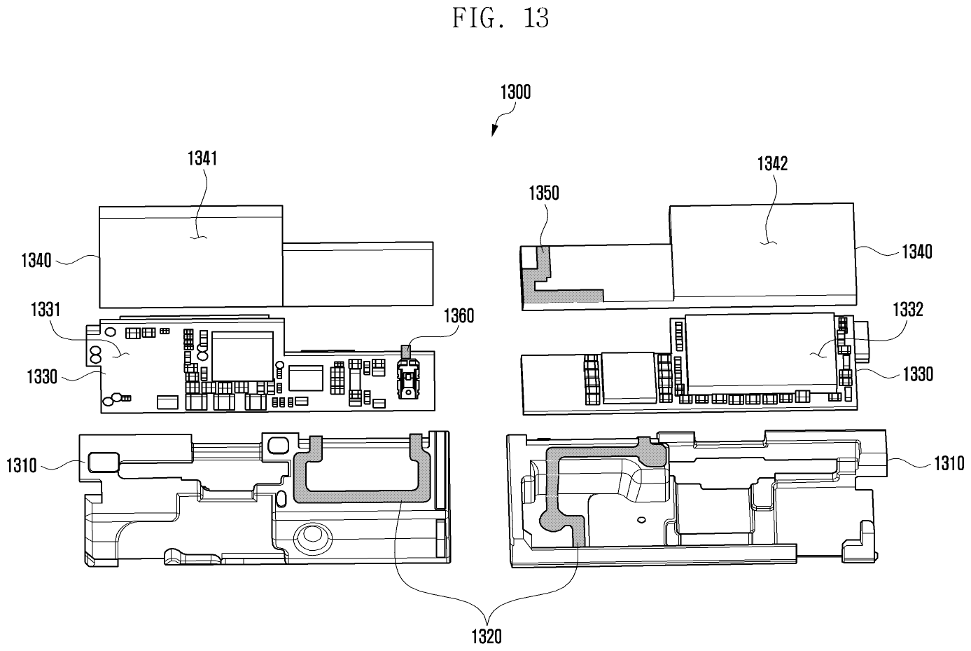

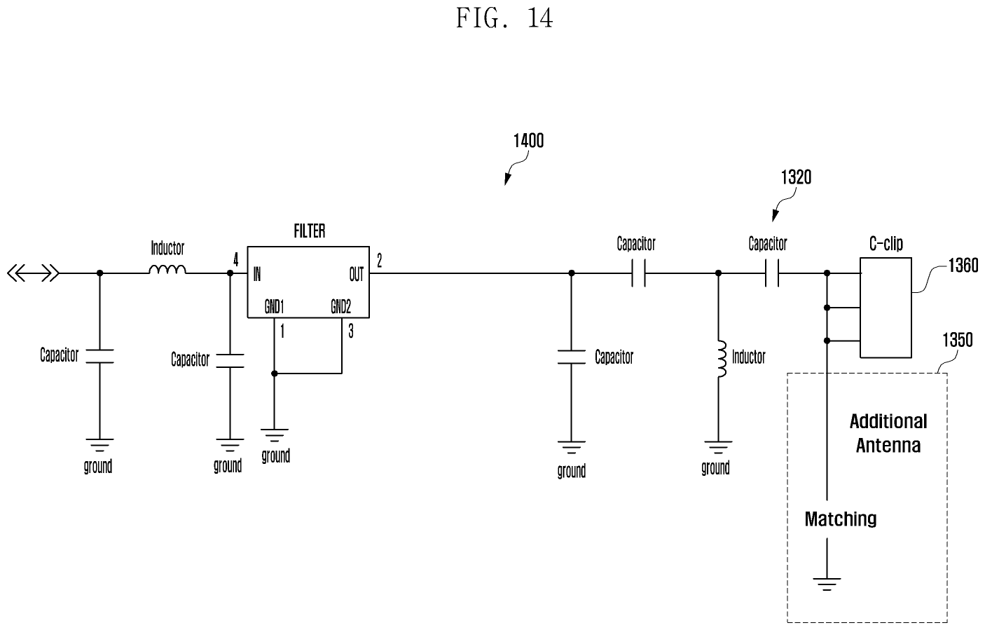

FIG. 13 is a diagram 1300 illustrating a first antenna structure disposed on an antenna carrier and a second antenna structure disposed on an outer surface (e.g., a second surface (rear surface), a third surface (side surface)) of a semiconductor packaging substrate (e.g., a SiP substrate) according to an embodiment of the disclosure. FIG. 14 is a circuit diagram 1400 of a first antenna structure disposed on an antenna carrier and a second antenna structure disposed on a semiconductor packaging substrate (e.g., a SiP substrate) of a wearable electronic device according to an embodiment of the disclosure.

Referring to FIGS. 13 and 14, a wearable electronic device (e.g., the wearable electronic device 400 of FIG. 4) according to various embodiments of the disclosure may include an antenna carrier 1310 (e.g., the antenna carrier 1210 of FIG. 12), a printed circuit board 1330 (PCB) (e.g., the printed circuit board 840 of FIG. 12), a semiconductor packaging substrate 1340 (a SiP substrate) (e.g., the semiconductor packaging substrate 850 of FIG. 12), a first antenna structure 1320 (a first antenna pattern) (e.g., the first antenna structure 1220 of FIG. 12), a second antenna structure 1350 (a second antenna pattern) (e.g., the second antenna structure 1250 of FIG. 12), and a contact structure 1360 (C-clip) (e.g., the contact structure 1260 of FIG. 12).

According to one embodiment of the disclosure, a first surface 1341 (e.g., a front surface) of the semiconductor packaging substrate 1340 (the SiP substrate) may be disposed to be in contact with a second surface 1332 (e.g., a rear surface) of the printed circuit board 1330. The first surface 1341 (e.g., the front surface) of the semiconductor packaging substrate 1340 (the SiP substrate) and the second surface 1332 (e.g., the rear surface) of the printed circuit board 1330 may be bonded by an adhesive material. For example, electronic components may be disposed on the first surface 1331 (e.g., the front surface) and the second surface 1332 (e.g., the rear surface) of the printed circuit board 1330.

According to one embodiment of the disclosure, a first antenna structure 1320 (a first antenna pattern) (e.g., the first antenna structure 1220 of FIG. 12) may be disposed on the antenna carrier 1310 (e.g., the antenna carrier 1210 of FIG. 12). For example, the first antenna structure 1320 (the first antenna pattern) disposed on the antenna carrier 1310 may include a conductive pattern to form a main feed.

According to one embodiment of the disclosure, a second antenna structure 1350 (a second antenna pattern) may be disposed on an outer surface (e.g., a second surface (rear surface), a third surface (side surface)) of the semiconductor packaging substrate 1340 (the SiP substrate).

According to one embodiment of the disclosure, the first antenna structure 1320 (the first antenna pattern) and the second antenna structure 1350 (the second antenna pattern) may be electrically connected by a contact structure 1360 (C-clip) disposed on the printed circuit board 1330 (PCB).

For example, the second antenna structure 1350 (the second antenna pattern) may be disposed on a second surface 1342 (e.g., a rear surface) of the outer surface of the semiconductor packaging substrate 1340 (the SiP substrate). For example, the second antenna structure 1350 (the second antenna pattern) may be disposed on at least a portion of the second surface 1342 (e.g., the rear surface) of the semiconductor packaging substrate 1340 (the SiP substrate). For example, the second antenna structure 1350 (the second antenna pattern) may not be disposed on a third surface 1343 (e.g., a side surface) of the semiconductor packaging substrate 1340 (the SiP substrate).

For example, the second antenna structure 1350 (the second antenna pattern) may include a conductive pattern for adjusting the length of the first antenna pattern 1320 (e.g., adjusting the length of the main feeding).

The wearable electronic device 400 (the TWS wireless earphone) according to an embodiment of the disclosure may improve antenna performance by disposing a second antenna structure 1350 (a second antenna pattern) (e.g., a main feed) on a second surface 1342 (e.g., a rear surface) of an outer surface of the semiconductor packaging substrate 1340 (the SiP substrate), thereby increasing the area of the overall antenna pattern of the wearable electronic device 400.

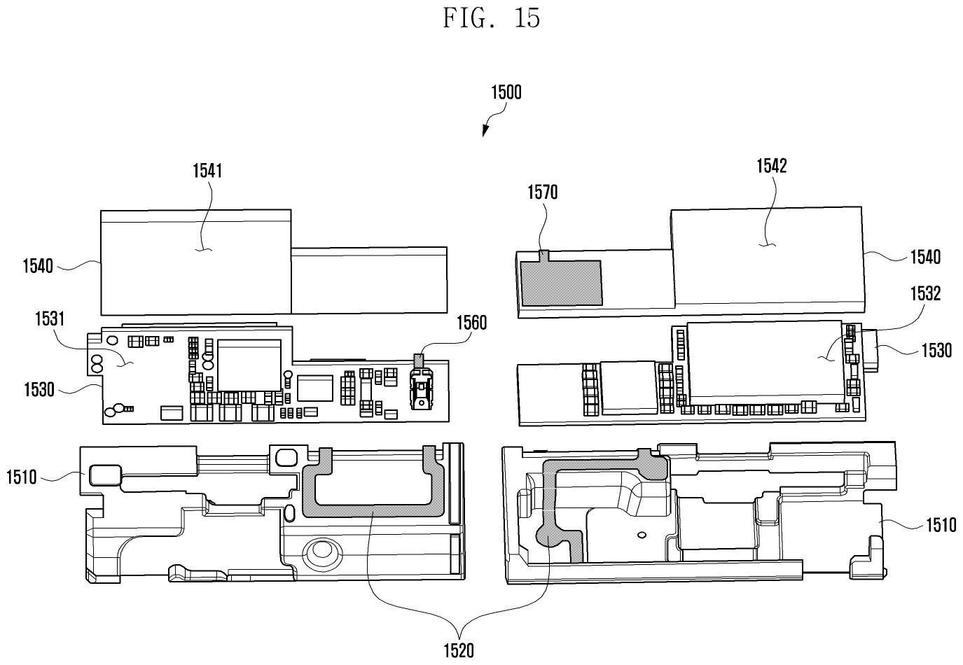

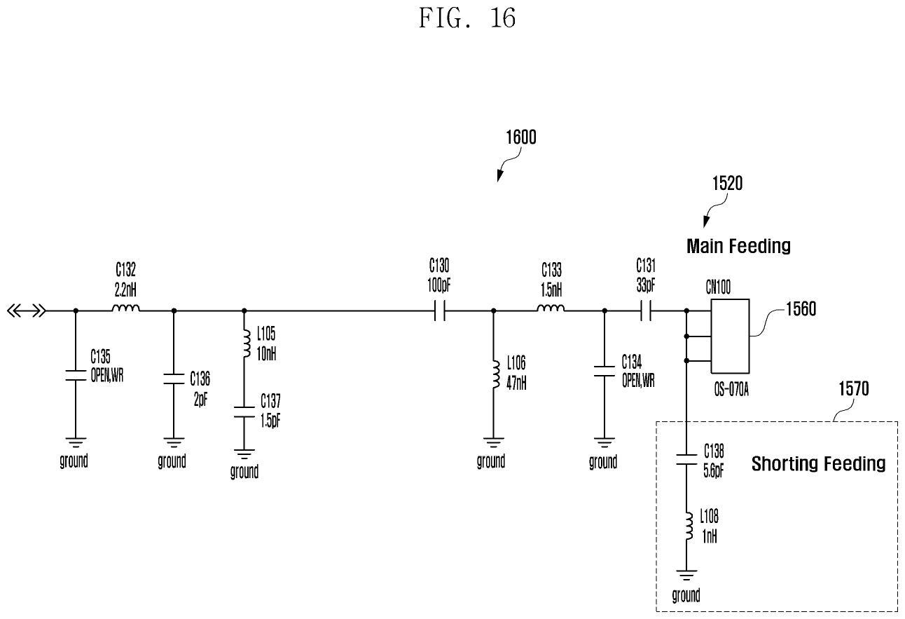

FIG. 15 is a diagram 1500 illustrating a first antenna structure disposed on an antenna carrier and a second antenna structure disposed on an outer surface (e.g., a second surface (rear surface), a third surface (side surface)) of a semiconductor packaging substrate (e.g., a SiP substrate) according to an embodiment of the disclosure. FIG. 16 is a circuit diagram 1600 of a first antenna structure disposed on an antenna carrier and a second antenna structure disposed on a semiconductor packaging substrate (e.g., a SiP substrate) of a wearable electronic device according to an embodiment of the disclosure.

Referring to FIGS. 15 and 16, a wearable electronic device (e.g., the wearable electronic device 400 of FIG. 4) according to various embodiments of the disclosure may include an antenna carrier 1510 (e.g., the antenna carrier 1210 of FIG. 12), a printed circuit board 1530 (PCB) (e.g., the printed circuit board 840 of FIG. 12), a semiconductor packaging substrate 1540 (a SiP substrate) (e.g., the semiconductor packaging substrate 850 of FIG. 12), a first antenna structure 1520 (a first antenna pattern) (e.g., the first antenna structure 1220 of FIG. 12), a second antenna structure 1570 (a second antenna pattern) (e.g., the second antenna structure 1250 of FIG. 12), and a contact structure 1560 (C-clip) (e.g., the contact structure 1260 of FIG. 12).

According to an embodiment of the disclosure, a first surface 1541 (e.g., a front surface) of the semiconductor packaging substrate 1540 (the SiP substrate) may be disposed to be in contact with a second surface (e.g., a rear surface) of the printed circuit board 1530. The first surface 1541 (e.g., the front surface) of the semiconductor packaging substrate 1540 (the SiP substrate) and the second surface (e.g., the rear surface) of the printed circuit board 1530 may be bonded by an adhesive material. For example, electronic components may be disposed on the first surface 1531 (e.g., the front surface) and the second surface 1532 (e.g., the rear surface) of the printed circuit board 1530.

According to one embodiment of the disclosure, a first antenna structure 1520 (a first antenna pattern) (e.g., the first antenna structure 1220 of FIG. 12) may be disposed on the antenna carrier 1510 (e.g., the antenna carrier 1210 of FIG. 12). For example, the first antenna structure 1520 (a first antenna pattern) disposed on the antenna carrier 1510 may include a conductive pattern to form a main feed.

According to one embodiment of the disclosure, a second antenna structure 1570 (a second antenna pattern) may be disposed on an outer surface (e.g., a second surface (rear surface), a third surface (side surface)) of the semiconductor packaging substrate 1540 (the SiP substrate).

According to one embodiment of the disclosure, the second antenna structure 1570 (the second antenna pattern) and the printed circuit board 1530 (PCB) may be electrically connected by a contact structure 1560 (C-clip) disposed on the printed circuit board 1530 (PCB).

For example, the second antenna structure 1570 (the second antenna pattern) may be disposed on a second surface 1542 (e.g., a rear surface) of an outer surface of the semiconductor packaging substrate 1540 (the SiP substrate). The second antenna structure 1570 (the second antenna pattern) may be disposed on at least a portion of the second surface 1542 (e.g., the rear surface) of the semiconductor packaging substrate 1540 (the SiP substrate). For example, the second antenna structure 1570 (the second antenna pattern) may not be disposed on a third surface 1543 (e.g., a side surface) of the semiconductor packaging substrate 1540 (the SiP substrate).

For example, the second antenna structure 1570 (the second antenna pattern) may include a conductive pattern to form a shorting feed of the antenna.

The wearable electronic device 400 (the TWS wireless earphone) according to an embodiment of the disclosure may improve antenna performance by disposing the second antenna structure 1570 (the second antenna pattern) (e.g., the shorting feed) on a second surface 1542 (e.g., a rear surface) of an outer surface of the semiconductor packaging substrate 1540 (the SiP substrate), thereby increasing the area of the overall antenna pattern of the wearable electronic device 400.

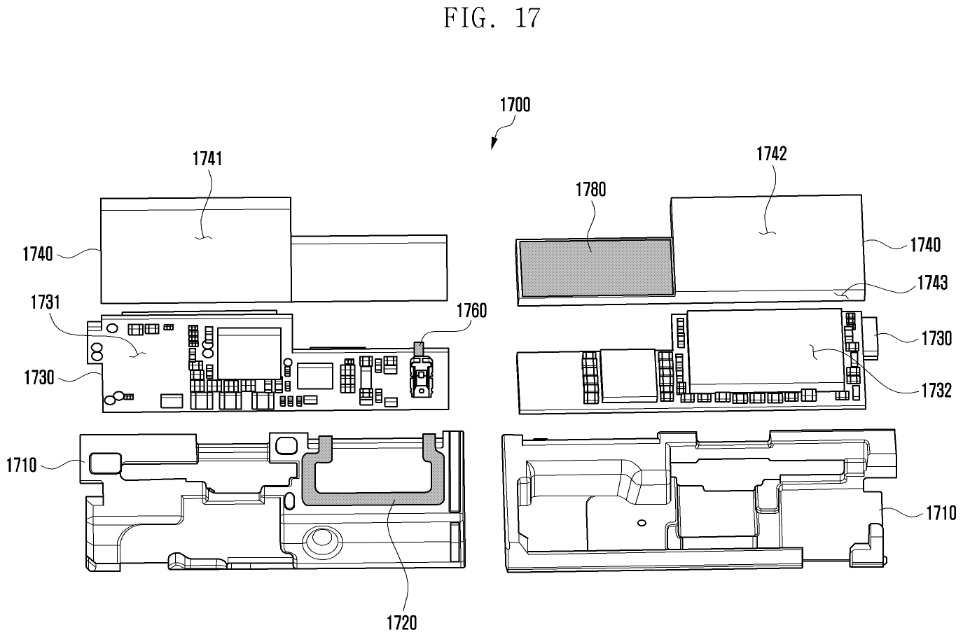

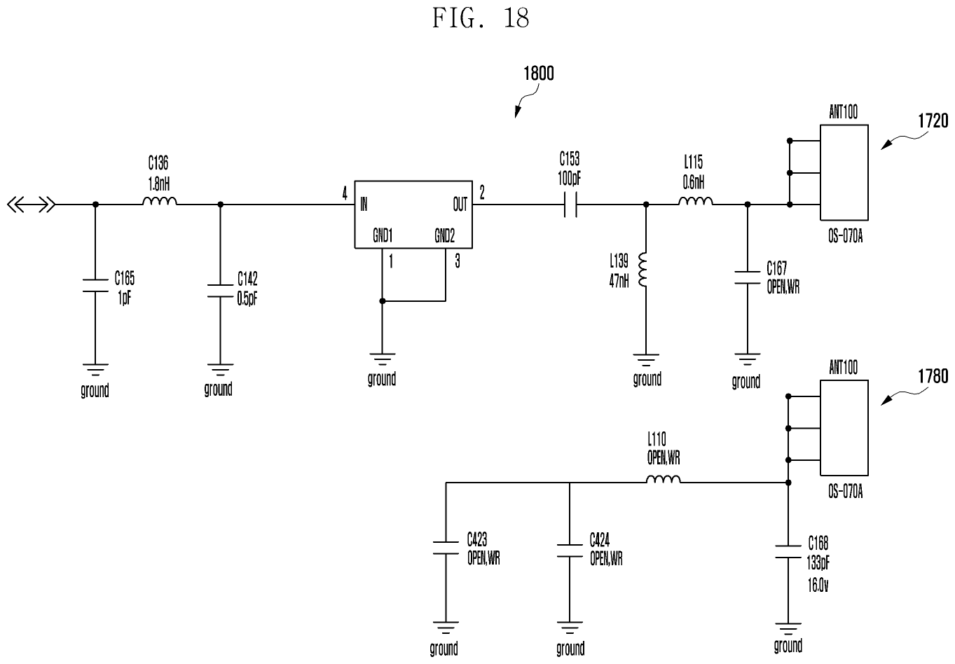

FIG. 17 is a diagram 1700 illustrating a first antenna structure disposed on an antenna carrier and a second antenna structure disposed on an outer surface (e.g., a second surface (rear surface), a third surface (side surface)) of a semiconductor packaging substrate (e.g., a SiP substrate) according to an embodiment of the disclosure. FIG. 18 is a circuit diagram 1800 of a first antenna structure disposed on an antenna carrier and a second antenna structure disposed on a semiconductor packaging substrate (e.g., a SiP substrate) of a wearable electronic device according to an embodiment of the disclosure.

Referring to FIGS. 17 and 18, a wearable electronic device (e.g., the wearable electronic device 400 of FIG. 4) according to various embodiments of the disclosure may include an antenna carrier 1710 (e.g., the antenna carrier 1210 of FIG. 12), a printed circuit board 1730 (PCB) (e.g., the printed circuit board 840 of FIG. 12), a semiconductor packaging substrate 1740 (a SiP substrate) (e.g., the semiconductor packaging substrate 850 of FIG. 12), a first antenna structure 1720 (a first antenna pattern) (e.g., the first antenna structure 1220 of FIG. 12), a second antenna structure 1780 (a second antenna pattern) (e.g., the second antenna structure 1250 of FIG. 12), and a contact structure 1760 (C-clip) (e.g., the contact structure 1260 of FIG. 12).

According to one embodiment of the disclosure, a first surface 1741 (e.g., a front surface) of the semiconductor packaging substrate 1740 (the SiP substrate) may be disposed to be in contact with a second surface 1741 (e.g., a rear surface) of the printed circuit board 1730. The first surface 1741 (e.g., the front surface) of the semiconductor packaging substrate 1740 (the SiP substrate) and the second surface (e.g., the rear surface) of the printed circuit board 1730 may be bonded by an adhesive material. For example, electronic components may be disposed on a first surface 1731 (e.g., the front surface) and a second surface 1732 (e.g., the rear surface) of the printed circuit board 1730.

According to one embodiment of the disclosure, a first antenna structure 1720 (e.g., a first antenna pattern) (e.g., the first antenna structure 1220 of FIG. 12) may be disposed on the antenna carrier 1710 (e.g., the antenna carrier 1210 of FIG. 12). For example, the first antenna structure 1720 (the first antenna pattern) disposed on the antenna carrier 1710 may include a conductive pattern to form a main feed.

According to one embodiment of the disclosure, a second antenna structure 1780 (a second antenna pattern) may be disposed on an outer surface (e.g., a second surface (rear surface), a third surface (side surface)) of the semiconductor packaging substrate 1740 (the SiP substrate).

According to one embodiment of the disclosure, the second antenna structure 1780 (the second antenna pattern) and the printed circuit board 1730 (PCB) may be electrically connected by a contact structure 1760 (C-clip) disposed on the printed circuit board 1730 (PCB).

For example, the second antenna structure 1780 (the second antenna pattern) may be disposed on a second surface 1742 (e.g., a rear surface) of an outer surface of the semiconductor packaging substrate 1840 (the SiP substrate). The second antenna structure 1780 (the second antenna pattern) may be disposed on at least a portion of the second surface 1742 (e.g., the rear surface) of the semiconductor packaging substrate 1540 (the SiP substrate). For example, the second antenna structure 1780 (the second antenna pattern) may not be disposed on a third surface 1743 (e.g., a side surface) of the semiconductor packaging substrate 1740 (the SiP substrate).

For example, the second antenna structure 1780 (the second antenna pattern) may include a conductive pattern to form an antenna ground.

The wearable electronic device 400 (the TWS wireless earphone) according to an embodiment of the disclosure may improve antenna performance by disposing the second antenna structure 1780 (the second antenna pattern) (e.g., the antenna ground) on a second surface 1742 (e.g., a rear surface) of the outer surface of the semiconductor packaging substrate 1740 (the SiP substrate), thereby increasing the area of the overall antenna pattern of the wearable electronic device 400.

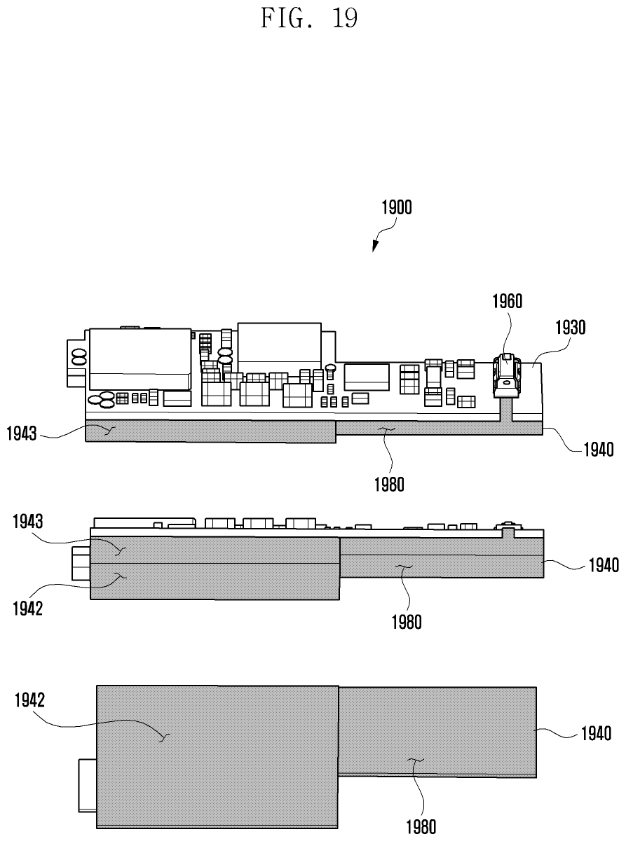

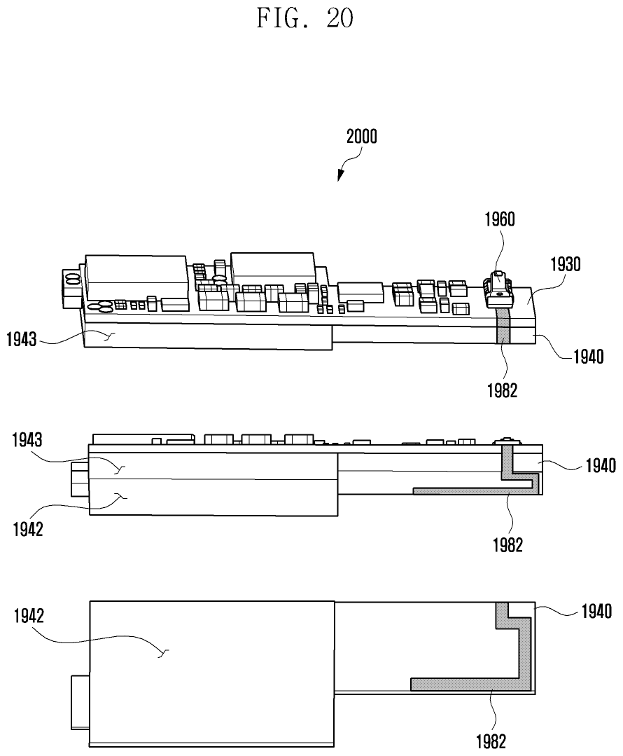

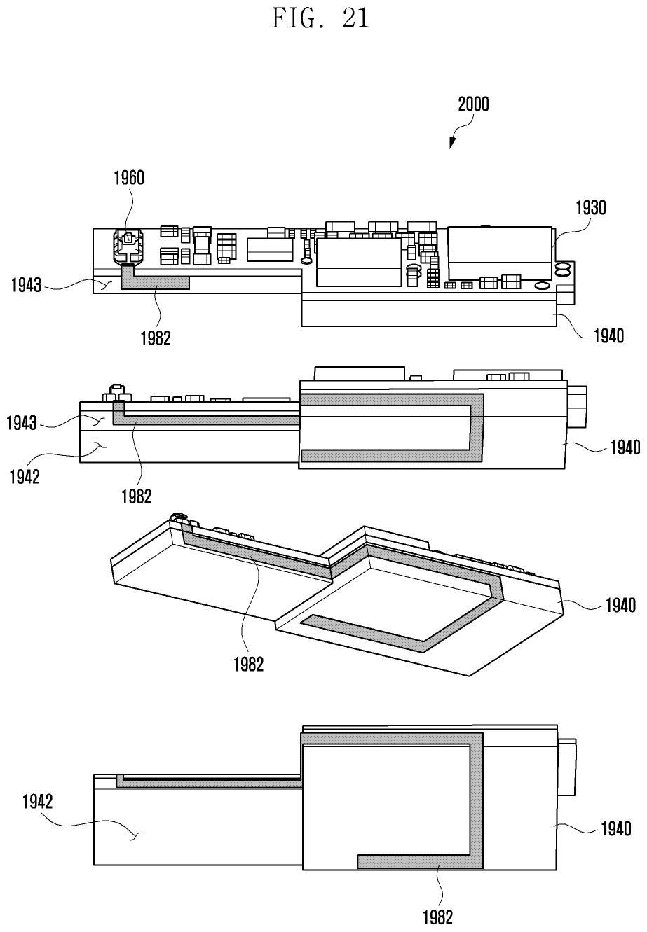

FIG. 19 is a diagram 1900 illustrating a first antenna structure disposed on an antenna carrier and a second antenna structure disposed on an outer surface (e.g., a second surface (rear surface), a third surface (side surface)) of a semiconductor packaging substrate (e.g., a SiP substrate) according to an embodiment of the disclosure. FIGS. 20 and 21 are diagrams 2000 illustrating a second antenna structure, a contact structure, and a connection pattern electrically connecting the second antenna structure and the contact structure to an outer surface (e.g., a second surface (rear surface), a third surface (side surface)) of a semiconductor packaging substrate (e.g., a SiP substrate) according to various embodiments of the disclosure.

Referring to FIGS. 19 to 21, a wearable electronic device (e.g., the wearable electronic device 400 of FIG. 4) according to various embodiments of the disclosure may include an antenna carrier (e.g., the antenna carrier 1210 of FIG. 12), a printed circuit board 1930 (PCB) (e.g., the printed circuit board 840 of FIG. 12), a semiconductor packaging substrate 1940 (a SiP substrate) (e.g., the semiconductor packaging substrate 850 of FIG. 12), a first antenna structure (a first antenna pattern) (e.g., the first antenna structure 1220 of FIG. 12, the first antenna structure 1720 of FIG. 17), a second antenna structure 1980 (a second antenna pattern) (e.g., the second antenna structure 1250 of FIG. 12), and a contact structure 1960 (C-clip) (e.g., the contact structure 1260 of FIG. 12).

According to one embodiment of the disclosure, a first surface (e.g., a front surface) of the semiconductor packaging substrate 1940 (the SiP substrate) may be disposed to be in contact with a second surface (e.g., a rear surface) of the printed circuit board 1930. The first surface (e.g., the front surface) of the semiconductor packaging substrate 1940 (the SiP substrate) and the second surface (e.g., the rear surface) of the printed circuit board 1930 may be bonded by an adhesive material.

According to one embodiment of the disclosure, a second antenna structure 1980 (a second antenna pattern) may be disposed on an outer surface (e.g., a second surface (rear surface), a third surface (side surface)) of the semiconductor packaging substrate 1940 (the SiP substrate). For example, the second antenna structure 1980 (the second antenna pattern) may be disposed on all or a portion of the second surface 1942 (e.g., the rear surface) of the semiconductor packaging substrate 1940 (the SiP substrate). For example, the second antenna structure 1980 (the second antenna pattern) may be disposed on all or a portion of a third surface 1943 (e.g., a side surface) of the semiconductor packaging substrate 1940 (the SiP substrate).

According to one embodiment of the disclosure, the second antenna structure 1980 (the second antenna pattern) and the printed circuit board 1930 (PCB) may be electrically connected by a contact structure 1960 (C-clip) disposed on the printed circuit board 1930 (PCB).

For example, the second antenna structure 1980 (the second antenna pattern) may be disposed on at least a portion of a second surface 1942 (e.g., a rear surface) and a third surface 1943 (e.g., a side surface) of an outer surface of the semiconductor packaging substrate 1940 (the SiP substrate).

For example, the second antenna structure 1980 (the second antenna pattern) may include a conductive pattern to form an antenna ground.

For example, a second antenna structure 1980 (a second antenna pattern) to form an antenna ground may be disposed on all or at least a portion of the second surface 1942 (e.g., the rear surface) and the third surface 1943 (e.g., the side surface) of the semiconductor packaging substrate 1940 (the SiP substrate).

According to one embodiment of the disclosure, a connection pattern 1982 may be disposed to electrically connect the antenna structure 1980 (the second antenna pattern) and the contact structure 1960 (C-clip) formed on all or at least part of the second surface 1942 (e.g., the rear surface) and the third surface 1943 (e.g., the side surface) of the semiconductor packaging substrate 1940 (the SiP substrate).

For example, the connection pattern 1982 may be disposed on at least a portion of the printed circuit board 1930 (PCB) and at least a portion of the semiconductor packaging substrate 1940 (the SiP substrate).

For example, the connection pattern 1982 may be disposed on a second surface 1942 (e.g., a rear surface) of the semiconductor packaging substrate 1940 (the SiP substrate).

For example, the connection pattern 1982 may be disposed on a third surface 1943 (e.g., a side surface) of the semiconductor packaging substrate 1940 (the SiP substrate).

For example, the connection pattern 1982 may be disposed on the second surface 1942 (e.g., the rear surface) and the third surface 1943 (e.g., the side surface) of the semiconductor packaging substrate 1940 (the SiP substrate).

The wearable electronic device 400 (the TWS wireless earphone) according to an embodiment of the disclosure may improve antenna performance by disposing a second antenna structure 1980 (a second antenna pattern) (e.g., an antenna ground) on all or a portion of the second surface 1942 (e.g., the rear surface) and the third surface 1943 (e.g., the side surface) of the outer surface of the semiconductor packaging substrate 1940 (the SiP substrate), thereby increasing the area of the overall antenna pattern of the wearable electronic device 400.

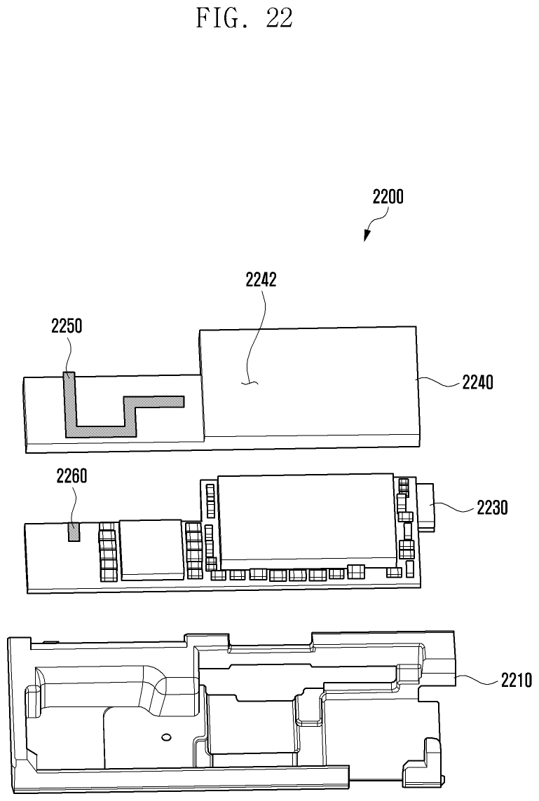

FIG. 22 is a diagram 2200 illustrating an antenna structure disposed on an outer surface (e.g., a second surface (rear surface), a third surface (side surface)) of a semiconductor packaging substrate (e.g., a SiP substrate) according to an embodiment of the disclosure.

Referring to FIG. 22, a wearable electronic device (e.g., the wearable electronic device 400 of FIG. 4) according to an embodiment of the disclosure may include a support structure 2210, a printed circuit board 2230 (PCB) (e.g., the printed circuit board 840 of FIG. 12), a semiconductor packaging substrate 2240 (a SiP substrate) (e.g., the semiconductor packaging substrate 850 of FIG. 12), an antenna structure 2250 (an antenna pattern), and a contact structure 2260 (C-clip) (e.g., the contact structure 1260 of FIG. 12).

For example, the support structure 2210 may form a space in which the printed circuit board 2230 (PCB) and the semiconductor packaging substrate 2240 (the SiP substrate) are disposed, and the printed circuit board 2230 (PCB) and the semiconductor packaging substrate 2240 (the SiP substrate) may be disposed in the space formed through the support structure 2210. The support structure 2210 may protect the printed circuit board 2230 (PCB) and the semiconductor packaging substrate 2240 (the SiP substrate) by absorbing external shocks applied to the printed circuit board 2230 (PCB) and the semiconductor packaging substrate 2240 (the SiP substrate).

According to one embodiment of the disclosure, a first surface (e.g., a front surface) of the semiconductor packaging substrate 2240 (the SiP substrate) may be disposed to be in contact with a second surface (e.g., a rear surface) of the printed circuit board 2230. The first surface (e.g., the front surface) of the semiconductor packaging substrate 2240 (the SiP substrate) and the second surface (e.g., the rear surface) of the printed circuit board 2230 may be bonded by an adhesive material.

According to one embodiment of the disclosure, an antenna structure 2250 (an antenna pattern) may be disposed on an outer surface (e.g., a second surface (rear surface), a third surface (side surface)) of the semiconductor packaging substrate 2240 (the SiP substrate).

According to one embodiment of the disclosure, the antenna structure 2250 (the antenna pattern) may be electrically connected to the printed circuit board 2230 (PCB) by a contact structure 2260 (C-clip) disposed on the printed circuit board 2230 (PCB).

For example, the antenna structure 2250 (the antenna pattern) may be disposed on a second surface 2242 (e.g., a rear surface) of an outer surface of the semiconductor packaging substrate 2240 (the SiP substrate). The antenna structure 2250 (the antenna pattern) may be disposed on at least a portion of the second surface 2242 (e.g., the rear surface) of the semiconductor packaging substrate 2240 (the SiP substrate).

For example, the antenna structure 2250 (the antenna pattern) may include a conductive pattern to form a main feed of the antenna.

The wearable electronic device 400 (the TWS wireless earphone) according to an embodiment of the disclosure may dispose the antenna structure 2250 (the antenna pattern) (e.g., the main feed) on a second surface 2242 (e.g., a rear surface) of the outer surface of the semiconductor packaging substrate 2240 (the SiP substrate) to increase the area of the overall antenna pattern of the wearable electronic device 400, thereby improving antenna performance.

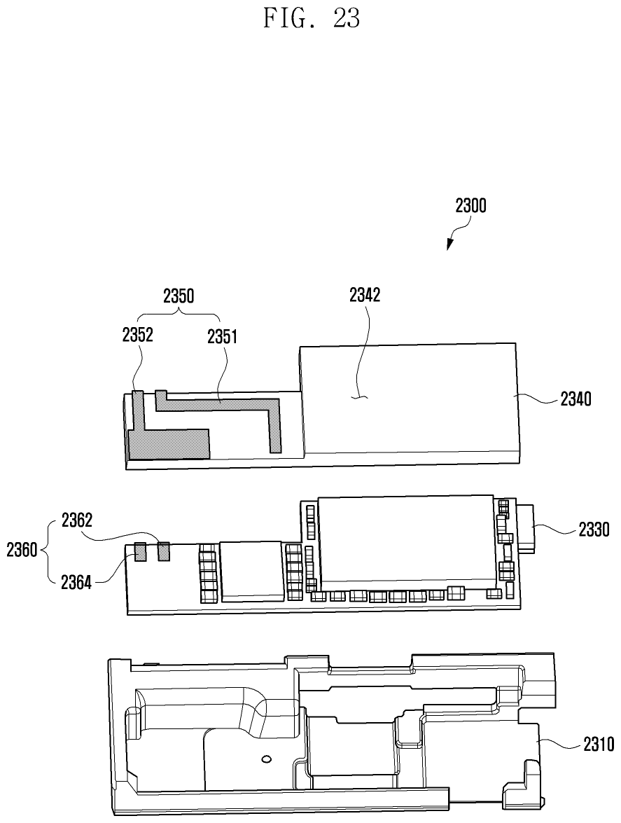

FIG. 23 is a diagram illustrating an antenna structure 2300 disposed on an outer surface (e.g., a second surface (rear surface), a third surface (side surface)) of a semiconductor packaging substrate (e.g., a SiP substrate) according to an embodiment of the disclosure.

Referring to FIG. 23, a wearable electronic device (e.g., the wearable electronic device 400 of FIG. 4) according to an embodiment of the disclosure may include: a support structure 2310, a printed circuit board 2330 (PCB) (e.g., the printed circuit board 840 of FIG. 12), a semiconductor packaging substrate 2340 (a SiP substrate) (e.g., the semiconductor packaging substrate 850 of FIG. 12), an antenna structure 2350 (e.g., an antenna pattern), and a contact structure 2360 (C-clip) (e.g., the contact structure 1260 of FIG. 12).

For example, the support structure 2310 may form a space in which the printed circuit board 2230 (PCB) and the semiconductor packaging substrate 2340 (the SiP substrate) are disposed, and the printed circuit board 2230 (PCB) and the semiconductor packaging substrate 2340 (the SiP substrate) may be disposed in the space formed through the support structure 2310. The support structure 2310 may protect the printed circuit board 2230 (PCB) and the semiconductor packaging substrate 2340 (the SiP substrate) by absorbing external shocks applied to the printed circuit board 2230 (PCB) and the semiconductor packaging substrate 2340 (the SiP substrate).

According to one embodiment of the disclosure, a first surface (e.g., a front surface) of the semiconductor packaging substrate 2340 (the SiP substrate) may be disposed to be in contact with a second surface (e.g., a rear surface) of the printed circuit board 2330. The first surface (e.g., the front surface) of the semiconductor packaging substrate 2340 (the SiP substrate) and the second surface (e.g., the rear surface) of the printed circuit board 2330 may be bonded by an adhesive material.

According to one embodiment of the disclosure, an antenna structure 2350 (e.g., an antenna pattern) may be disposed on an outer surface (e.g., a second surface (rear surface), a third surface (side surface)) of the semiconductor packaging substrate 2340 (the SiP substrate).

According to one embodiment of the disclosure, the antenna structure 2350 (e.g., the antenna pattern) may be electrically connected to the printed circuit board 2330 (PCB) by a contact structure 2360 (C-clip) disposed on the printed circuit board 2330 (PCB).

For example, the antenna structure 2350 (e.g., the antenna pattern) may be disposed on a second surface 2342 (e.g., a rear surface) of an outer surface of the semiconductor packaging substrate 2340 (the SiP substrate). The antenna structure 2350 (e.g., the antenna pattern) may be disposed on at least a portion of the second surface 2342 (e.g., the rear surface) of the semiconductor packaging substrate 2340 (e.g., the SiP substrate).

For example, the antenna structure 2350 (e.g., the antenna pattern) may include a first conductive pattern to form a main feed 2351 of the antenna, and a second conductive pattern to form a shorting feed 2352 of the antenna.

For example, the contact structure 2360 (C-clip) may include a first conductive pattern to form the main feed 2351 of the antenna and a first contact 2362 for electrically connecting the printed circuit board 2330.

For example, the contact structure 2360 (C-clip) may include a second contact portion 2364 electrically connecting the printed circuit board 2330 with a second conductive pattern to form a shorting feed 2352 (a shorting feed) of the antenna.

The wearable electronic device 400 (the TWS wireless earphone) according to an embodiment of the disclosure may dispose the antenna structures 2350 (e.g., the main feed and the shorting feed) on a second surface 2342 (e.g., a rear surface) of an outer surface of the semiconductor packaging substrate 2340 (e.g., a SiP substrate) to increase the area of the overall antenna pattern of the wearable electronic device 400, thereby improving antenna performance.

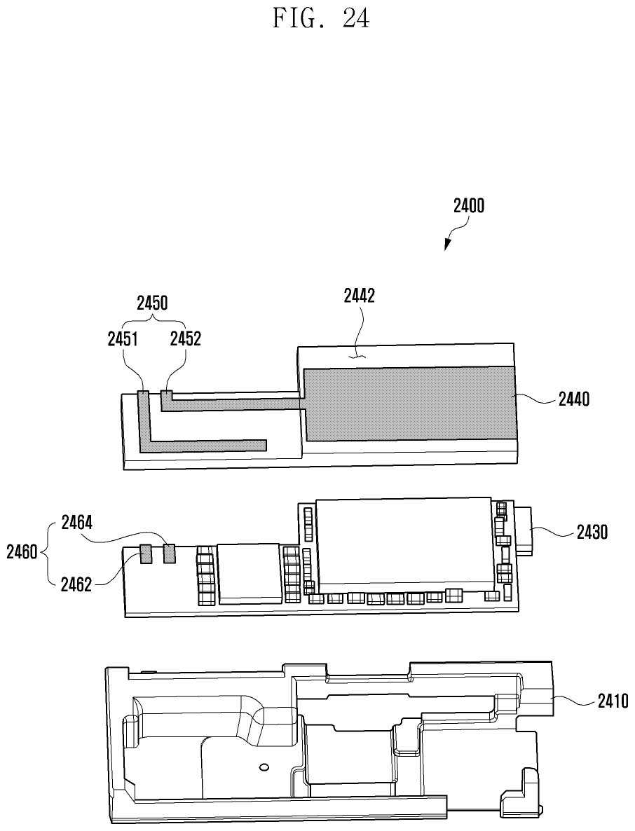

FIG. 24 is a diagram illustrating an antenna structure 2400 disposed on an outer surface (e.g., a second surface (rear surface), a third surface (side surface)) of a semiconductor packaging substrate (e.g., a SiP substrate) according to an embodiment of the disclosure.

Referring to FIG. 24, a wearable electronic device (e.g., the wearable electronic device 400 of FIG. 4) according to an embodiment of the disclosure may include: a support structure 2410, a printed circuit board 2430 (PCB) (e.g., the printed circuit board 840 of FIG. 12), a semiconductor packaging substrate 2440 (e.g., a SiP substrate 850 of FIG. 12), an antenna structure 2450 (e.g., an antenna pattern), and a contact structure 2460 (e.g., C-clip) (e.g., the contact structure 1260 of FIG. 12).

For example, the support structure 2410 may form a space in which the printed circuit board 2430 (PCB) and the semiconductor packaging substrate 2440 (the SiP substrate) are disposed, and the printed circuit board 2430 (PCB) and the semiconductor packaging substrate 2440 (the SiP substrate) may be disposed in the space formed through the support structure 2410. The support structure 2410 may protect the printed circuit board 2430 (PCB) and the semiconductor packaging substrate 2440 (the SiP substrate) by absorbing external shocks applied to the printed circuit board 2430 (PCB) and the semiconductor packaging substrate 2440 (the SiP substrate).

According to one embodiment of the disclosure, a first surface (e.g., a front surface) of the semiconductor packaging substrate 2440 (the SiP substrate) may be disposed to be in contact with a second surface (e.g., a rear surface) of the printed circuit board 2430. The first surface (e.g., the front surface) of the semiconductor packaging substrate 2440 (the SiP substrate) and the second surface (e.g., the rear surface) of the printed circuit board 2430 may be bonded by an adhesive material.

According to one embodiment of the disclosure, an antenna structure 2450 (e.g., an antenna pattern) may be disposed on an outer surface (e.g., a second surface (rear surface), a third surface (side surface)) of the semiconductor packaging substrate 2440 (the SiP substrate).

According to one embodiment of the disclosure, the antenna structure 2450 (e.g., the antenna pattern) may be electrically connected to the printed circuit board 2430 (PCB) by a contact structure 2460 (C-clip) disposed on the printed circuit board 2430 (PCB).

For example, the antenna structure 2450 (e.g., the antenna pattern) may be disposed on a second surface 2442 (e.g., a rear surface) of an outer surface of the semiconductor packaging substrate 2440 (the SiP substrate). The antenna structure 2450 (e.g., the antenna pattern) may be disposed on at least a portion of the second surface 2442 (e.g., the rear surface) of the semiconductor packaging substrate 2440 (e.g., the SiP substrate).

For example, the antenna structure 2450 (e.g., the antenna pattern) may include a first conductive pattern to form a main feed 2451 of the antenna, and a second conductive pattern to form a ground 2452 of the antenna.

For example, the contact structure 2460 (C-clip) may include a first conductive pattern to form the main feed 2451 of the antenna and a first contact 2462 for electrically connecting the printed circuit board 2430.

For example, the contact structure 2460 (C-clip) may include a second contact 2464 electrically connecting the printed circuit board 2430 with a second conductive pattern to form an antenna ground 2452.

The wearable electronic device 400 (the TWS wireless earphones) according to an embodiment of the disclosure may improve antenna performance by disposing the antenna structures 2450 (e.g., the main feed and the ground) on a second surface 2442 (e.g., a rear surface) of the outer surface of the semiconductor packaging substrate 2440 (the SiP substrate), thereby increasing the area of the overall antenna pattern of the wearable electronic device 400.

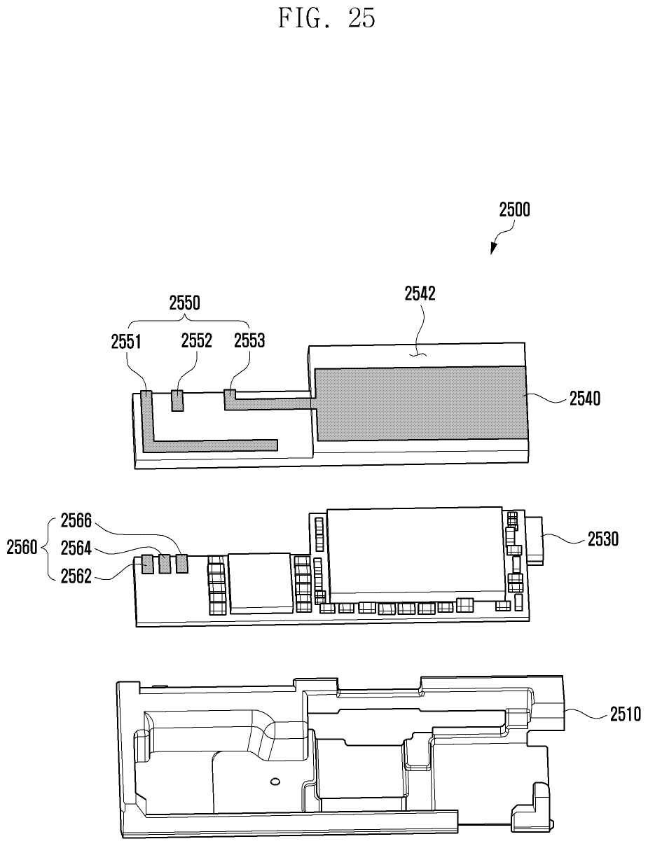

FIG. 25 is a diagram 2500 illustrating an antenna structure disposed on an outer surface (e.g., a second surface (rear surface), a third surface (side surface)) of a semiconductor packaging substrate (e.g., a SiP substrate) according to an embodiment of the disclosure.

Referring to FIG. 25, a wearable electronic device (e.g., the wearable electronic device 400 of FIG. 4) according to an embodiment of the disclosure may include: a support structure 2510, a printed circuit board 2530 (PCB) (e.g., the printed circuit board 840 of FIG. 12), a semiconductor packaging substrate 2540 (a SiP substrate) (e.g., the semiconductor packaging substrate 850 of FIG. 12), an antenna structure 2450 (e.g., an antenna pattern), and a contact structure 2560 (e.g., C-clip) (e.g., the contact structure 1260 of FIG. 12).

For example, the support structure 2510 may form a space in which the printed circuit board 2530 (PCB) and the semiconductor packaging substrate 2540 (the SiP substrate) are disposed, and the printed circuit board 2530 (PCB) and the semiconductor packaging substrate 2540 (the SiP substrate) may be disposed in the space formed through the support structure 2510. The support structure 2510 may protect the printed circuit board 2530 (PCB) and the semiconductor packaging substrate 2540 (the SiP substrate) by absorbing external shocks applied to the printed circuit board 2530 (PCB) and the semiconductor packaging substrate 2540 (the SiP substrate).

According to one embodiment of the disclosure, a first surface (e.g., a front surface) of the semiconductor packaging substrate 2540 (the SiP substrate) may be disposed to be in contact with a second surface (e.g., a rear surface) of the printed circuit board 2530. The first surface (e.g., the front surface) of the semiconductor packaging substrate 2540 (the SiP substrate) and the second surface (e.g., the rear surface) of the printed circuit board 2530 may be bonded by an adhesive material.

According to one embodiment of the disclosure, an antenna structure 2550 (e.g., an antenna pattern) may be disposed on an outer surface (e.g., a second surface (rear surface), a third surface (side surface)) of the semiconductor packaging substrate 2540 (the SiP substrate).

According to one embodiment of the disclosure, the antenna structure 2550 (e.g., the antenna pattern) may be electrically connected to the printed circuit board 2530 (PCB) by a contact structure 2560 (C-clip) disposed on the printed circuit board 2530 (PCB).

For example, the antenna structure 2550 (e.g., the antenna pattern) may be disposed on a second surface 2542 (e.g., a rear surface) of an outer surface of the semiconductor packaging substrate 2540 (the SiP substrate). The antenna structure 2550 (e.g., the antenna pattern) may be disposed on at least a portion of the second surface 2542 (e.g., a rear surface) of the semiconductor packaging substrate 2540 (e.g., a SiP substrate).

For example, the antenna structure 2550 (e.g., the antenna pattern) may include a first conductive pattern to form a main feed 2551 of the antenna, a second conductive pattern to form a shorting feed 2552, and a third conductive pattern to form a ground 2553.

For example, the contact structure 2560 (C-clip) may include a first conductive pattern to form the main feed 2551 (the main feed) of the antenna and a first contact 2562 for electrically connecting the printed circuit board 2530.

For example, the contact structure 2560 (C-clip) may include a second contact portion 2564 electrically connecting the printed circuit board 2530 with a second conductive pattern to form a shorting feed 2552 of the antenna.

For example, the contact structure 2560 (C-clip) may include a third contact portion 2566 electrically connecting the printed circuit board 2530 with a third conductive pattern to form the antenna ground 2553.

The wearable electronic device 400 (the TWS wireless earphones) according to an embodiment of the disclosure may improve antenna performance by disposing the antenna structures 2550 (e.g., the main feed, the short feed, and the ground) on a second surface 2542 (e.g., a rear surface) of the outer surface of the semiconductor packaging substrate 2540 (the SiP substrate), thereby increasing the area of the overall antenna pattern of the wearable electronic device 400.

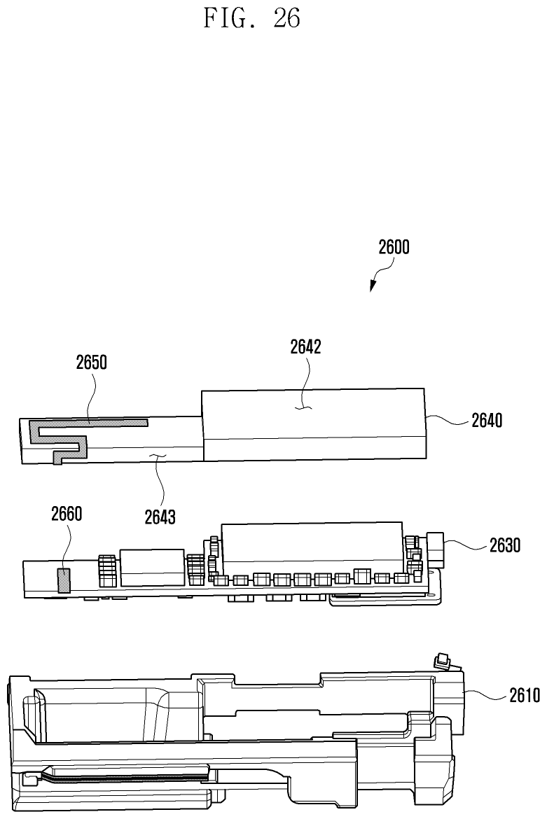

FIG. 26 is a diagram 2600 illustrating an antenna structure disposed on an outer surface (e.g., a second surface (rear surface), a third surface (side surface)) of a semiconductor packaging substrate (e.g., a SiP substrate) according to an embodiment of the disclosure.

Referring to FIG. 26, a wearable electronic device (e.g., the wearable electronic device 400 of FIG. 4) according to an embodiment of the disclosure may include: a support structure 2610, a printed circuit board 2630 (PCB) (e.g., the printed circuit board 840 of FIG. 12), a semiconductor packaging substrate 2640 (a SiP substrate) (e.g., the semiconductor packaging substrate 850 of FIG. 12), an antenna structure 2650 (e.g., an antenna pattern), and a contact structure 2660 (C-clip) (e.g., the contact structure 1260 of FIG. 12).

For example, the support structure 2610 may form a space in which the printed circuit board 2630 (PCB) and the semiconductor packaging substrate 2640 (the SiP substrate) are disposed, and the printed circuit board 2630 (PCB) and the semiconductor packaging substrate 2640 (the SiP substrate) may be disposed in the space formed through the support structure 2610. The support structure 2610 may protect the printed circuit board 2630 (PCB) and the semiconductor packaging substrate 2640 by absorbing external shocks applied to the printed circuit board 2630 (PCB) and the semiconductor packaging substrate 2640 (the SiP substrate).

According to one embodiment of the disclosure, a first surface (e.g., a front surface) of the semiconductor packaging substrate 2640 (the SiP substrate) may be disposed to be in contact with a second surface (e.g., a rear surface) of the printed circuit board 2630. The first surface (e.g., the front surface) of the semiconductor packaging substrate 2640 (the SiP substrate) and the second surface (e.g., the rear surface) of the printed circuit board 2630 may be bonded by an adhesive material.

According to one embodiment of the disclosure, an antenna structure 2650 (e.g., an antenna pattern) may be disposed on an outer surface of the semiconductor packaging substrate 2640 (e.g., the SiP substrate), such as a second surface 2642 (e.g., a rear surface) and a third surface 2643 (e.g., a side surface).

According to one embodiment of the disclosure, the antenna structure 2650 (e.g., the antenna pattern) may be electrically connected to the printed circuit board 2630 (PCB) by a contact structure 2660 (e.g., C-clip) disposed on the printed circuit board 2630 (PCB).

For example, the antenna structure 2650 (e.g., the antenna pattern) may be disposed on a second surface 2642 (e.g., a rear surface) and a third surface 2643 (e.g., a side surface) of an outer surface of the semiconductor packaging substrate 2640 (the SiP substrate). An antenna structure 2650 (e.g., an antenna pattern) may be disposed on a portion of the second surface 2642 (e.g., the rear surface) and the third surface 2643 (e.g., the side surface) of the semiconductor packaging substrate 2540 (the SiP substrate).

For example, the antenna structure 2650 (e.g., the antenna pattern) may include a conductive pattern to form a main feed of the antenna, or a conductive pattern to form a shorting feed, and/or a conductive pattern to form a ground.

For example, the contact structure 2660 (C-clip) may electrically connect the printed circuit board 2630 with the first conductive pattern to form the main feed of the antenna.

For example, the contact structure 2660 (C-clip) may electrically connect the printed circuit board 2630 with a second conductive pattern to form a shorting feed of the antenna.

For example, the contact structure 2660 (C-clip) may electrically connect the printed circuit board 2630 with a conductive pattern to form a ground of the antenna.

The wearable electronic device 400 (the TWS wireless earphones) according to an embodiment of the disclosure may improve antenna performance by disposing the antenna structures 2650 (e.g., the main feed, the short feed, and the ground) on a second surface 2642 (e.g., a rear surface) and a third surface 2643 (e.g., a side surface) of the outer surface of the semiconductor packaging substrate 2640 (the SiP substrate), thereby increasing the area of the overall antenna pattern of the wearable electronic device 400.

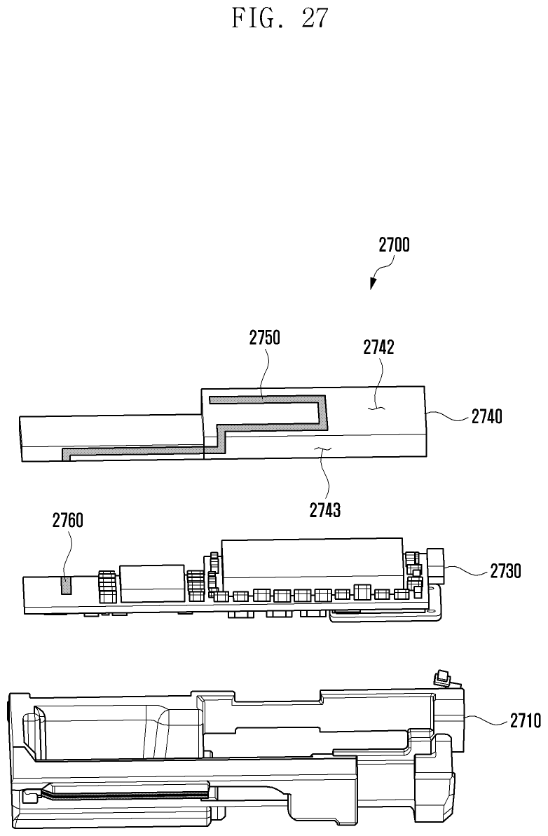

FIG. 27 is a diagram illustrating an antenna structure 2700 disposed on an outer surface (e.g., a second surface (rear surface), a third surface (side surface)) of a semiconductor packaging substrate (e.g., a SiP substrate) according to an embodiment of the disclosure.

Referring to FIG. 27, a wearable electronic device (e.g., the wearable electronic device 400 of FIG. 4) according to an embodiment of the disclosure may include a support structure 2710, a printed circuit board (PCB) 2730 (e.g., the printed circuit board 840 of FIG. 12), a semiconductor packaging substrate 2740 (a SiP substrate) (e.g., the semiconductor packaging substrate 850 of FIG. 12), an antenna structure 2750 (e.g., an antenna pattern), and a contact structure 2760 (C-clip) (e.g., the contact structure 1260 of FIG. 12).

For example, the support structure 2710 may form a space in which the printed circuit board 2730 (PCB) and the semiconductor packaging substrate 2740 (the SiP substrate) are disposed, and the printed circuit board 2730 (PCB) and the semiconductor packaging substrate 2740 (the SiP substrate) may be disposed in the space formed through the support structure 2710. The support structure 2710 may protect the printed circuit board 2730 (PCB) and the semiconductor packaging substrate 2740 by absorbing external shocks applied to the printed circuit board 2730 (PCB) and the semiconductor packaging substrate 2740 (the SiP substrate).

According to one embodiment of the disclosure, a first surface (e.g., a front surface) of the semiconductor packaging substrate 2740 (the SiP substrate) may be disposed to be in contact with a second surface (e.g., a rear surface) of the printed circuit board 2730. The first surface (e.g., the front surface) of the semiconductor packaging substrate 2740 (the SiP substrate) and the second surface (e.g., the rear surface) of the printed circuit board 2730 may be bonded by an adhesive material.

According to one embodiment of the disclosure, an antenna structure 2750 (e.g., an antenna pattern) may be disposed on an outer surface of the semiconductor packaging substrate 2740 (e.g., the SiP substrate), such as a second surface 2742 (e.g., a rear surface) and a third surface 2743 (e.g., a side surface).

According to one embodiment of the disclosure, the antenna structure 2750 (e.g., the antenna pattern) may be electrically connected to the printed circuit board 2730 (PCB) by a contact structure 2760 (e.g., C-clip) disposed on the printed circuit board 2730 (PCB).

For example, the antenna structure 2750 (e.g., the antenna pattern) may be disposed on a second surface 2742 (e.g., a rear surface) and a third surface 2743 (e.g., a side surface) of an outer surface of the semiconductor packaging substrate 2740 (the SiP substrate). The antenna structure 2750 (e.g., the antenna pattern) may be disposed on the entire surface of the second surface 2742 (e.g., the rear surface) and the third surface 2743 (e.g., the side surface) of the semiconductor packaging substrate 2740 (e.g., the SiP substrate).

For example, the antenna structure 2750 (e.g., the antenna pattern) may include a conductive pattern to form a main feed of the antenna, or a conductive pattern to form a shorting feed, and/or a conductive pattern to form a ground.

For example, the contact structure 2760 (C-clip) may electrically connect the printed circuit board 2730 with the first conductive pattern to form the main feed of the antenna.

For example, the contact structure 2760 (C-clip) may electrically connect the printed circuit board 2730 with a second conductive pattern to form a shorting feed of the antenna.

For example, the contact structure 2760 (C-clip) may electrically connect the printed circuit board 2730 with a conductive pattern to form a ground of the antenna.

The wearable electronic device 400 (the TWS wireless earphone) according to an embodiment of the disclosure may improve antenna performance by disposing the antenna structures 2750 (e.g., the main feed, the short feed, and the ground) on a second surface 2742 (e.g., a rear surface) and a third surface 2743 (e.g., a side surface) of the outer surface of the semiconductor packaging substrate 2740 (the SiP substrate), thereby increasing the area of the overall antenna pattern of the wearable electronic device 400.

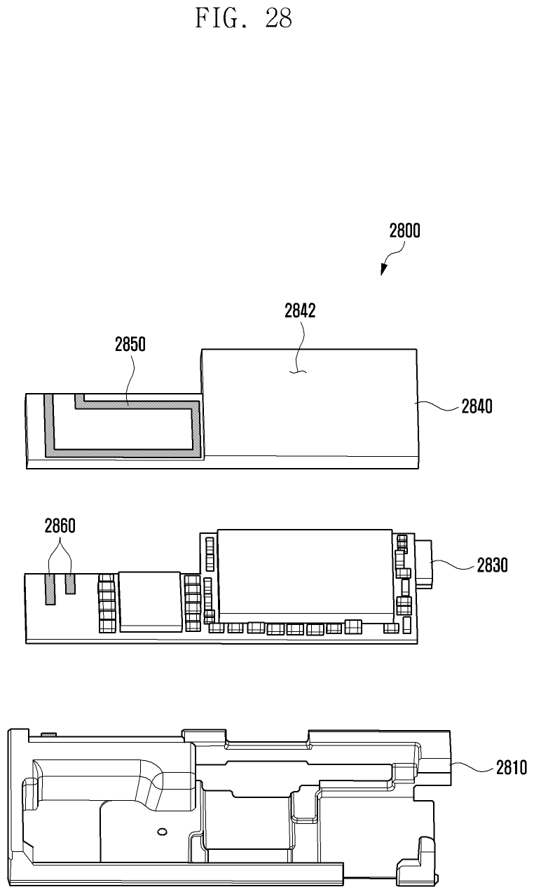

FIG. 28 is a diagram illustrating an antenna structure 2800 disposed on an outer surface (e.g., a second surface (rear surface), a third surface (side surface)) of a semiconductor packaging substrate (e.g., a SiP substrate) according to an embodiment of the disclosure.

Referring to FIG. 28, a wearable electronic device (e.g., the wearable electronic device 400 of FIG. 4) according to an embodiment of the disclosure may include a support structure 2810, a printed circuit board 2830 (PCB) (e.g., the printed circuit board 840 (PCB) of FIG. 12), a semiconductor packaging substrate 2840 (a SiP substrate) (e.g., the semiconductor packaging substrate 850 of FIG. 12), an antenna structure 2850 (an antenna pattern), and a contact structure 2860 (C-clip) (e.g., the contact structure 1260 of FIG. 12).

For example, the support structure 2810 may form a space in which the printed circuit board 2830 (PCB) and the semiconductor packaging substrate 2840 (the SiP substrate) are disposed, and the printed circuit board 2830 (PCB) and the semiconductor packaging substrate 2840 (the SiP substrate) may be disposed in the space formed through the support structure 2810. The support structure 2810 may protect the printed circuit board 2830 (PCB) and the semiconductor packaging substrate 2840 (the SiP substrate) by absorbing external shocks applied to the printed circuit board 2830 (PCB) and the semiconductor packaging substrate 2840 (the SiP substrate).

According to one embodiment of the disclosure, a first surface (e.g., a front surface) of the semiconductor packaging substrate 2840 (the SiP substrate) may be disposed to be in contact with a second surface (e.g., a rear surface) of the printed circuit board 2830. The first surface (e.g., the front surface) of the semiconductor packaging substrate 2840 (the SiP substrate) and the second surface (e.g., the rear surface) of the printed circuit board 2830 may be bonded by an adhesive material.

According to one embodiment of the disclosure, an antenna structure 2850 (an antenna pattern) may be disposed on an outer surface (e.g., a second surface (rear surface), a third surface (side surface)) of the semiconductor packaging substrate 2840 (the SiP substrate).

According to one embodiment of the disclosure, the antenna structure 2850 (the antenna pattern) may be electrically connected to the printed circuit board 2830 (PCB) by a contact structure 2860 (C-clip) disposed on the printed circuit board 2830 (PCB).

For example, the antenna structure 2850 (the antenna pattern) may be disposed on a second surface 2842 (e.g., a rear surface) of the outer surface of the semiconductor packaging substrate 2840 (the SiP substrate). The antenna structure 2850 (the antenna pattern) may be disposed on at least a portion of the second surface 2842 (e.g., the rear surface) of the semiconductor packaging substrate 2840 (the SiP substrate).

For example, the antenna structure 2850 (the antenna pattern) may include a conductive pattern to form a loop antenna.

According to another embodiment of the disclosure, the antenna structure 2850 (the antenna pattern) may be disposed on a third surface of an outer surface of the semiconductor packaging substrate 2840 (the SiP substrate). The antenna structure 2850 (the antenna pattern) may be disposed on at least a portion of the third surface of the semiconductor packaging substrate 2840 (the SiP substrate).

According to another embodiment of the disclosure, the antenna structure 2850 (the antenna pattern) may be disposed on the second surface 2842 (e.g., the rear surface) and the third surface (the side surface) of the outer surface of the semiconductor packaging plate 2840 (the SiP substrate). The antenna structure 2850 (the antenna pattern) may be disposed on at least a portion of the second surface 2842 (e.g., the rear surface) and the third surface (the side surface) of the semiconductor packaging plate 2840 (the SiP substrate).

The wearable electronic device 400 (the TWS wireless earphone) according to an embodiment of the disclosure may improve antenna performance by disposing the antenna structure 2850 (the loop antenna pattern) on at least one of the second surface 2842 (e.g., the rear surface) and the third surface (the side surface) of the outer surface of the semiconductor packaging substrate 2840 (the SiP substrate), thereby increasing the area of the overall antenna pattern of the wearable electronic device 400.

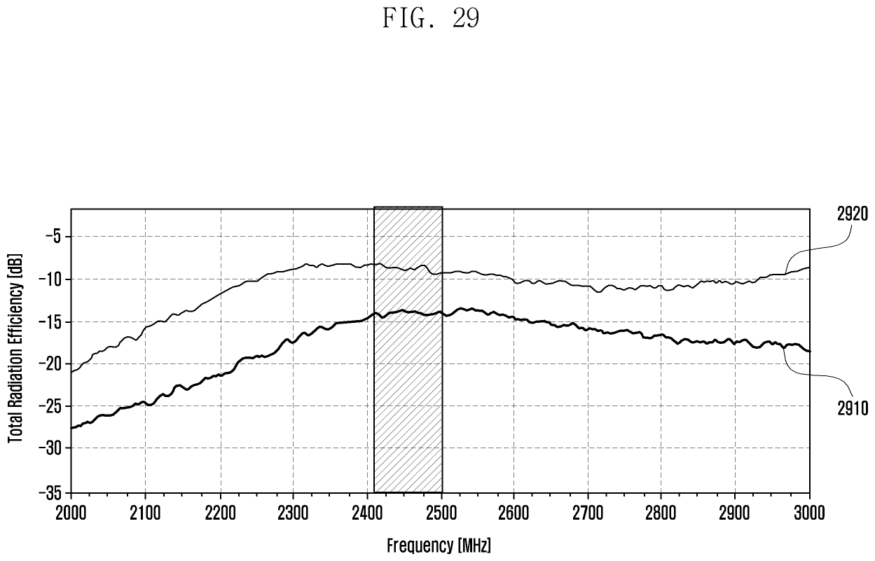

FIG. 29 is a diagram comparing the performance of an antenna of a wearable electronic device of a comparative example and an antenna of a wearable electronic device (e.g., a wearable electronic device 400 of FIG. 4) according to an embodiment of the disclosure.

Referring to FIG. 29, for example, a wearable electronic device 400 according to an embodiment of the disclosure may improve the performance of an antenna compared to a wearable electronic device of a comparative example by disposing an antenna pattern on a surface (e.g., a rear surface and/or a side surface) of a semiconductor packaging substrate (a SiP substrate). In FIG. 29, for example, a performance 2910 of an antenna with an antenna pattern disposed on an antenna carrier is illustrated compared to a performance 2920 of an antenna according to an embodiment of the disclosure.

When comparing the performance 2910 of the antenna of the comparative example to the performance 2920 of the antenna of the wearable electronic device 400 according to various embodiments of the disclosure, the performance of the antenna may be improved by disposing the antenna pattern on a surface (e.g., a rear surface and/or a side surface) of the semiconductor packaging substrate (the SiP substrate). The wearable electronic device 400 according to embodiments of the disclosure may utilize an antenna pattern disposed on a surface (e.g., a rear surface and/or a side surface) of the semiconductor packaging substrate (the SiP substrate) to optimize the performance of the antenna in a corresponding frequency band, thereby improving the maximum radiation performance of the antenna. For example, the average total radiation power (TRP) of the antenna of the wearable electronic device of the illustrated example may be about −8.63. The average TRP of the antenna of the wearable electronic device 400 according to an embodiment of the disclosure may be about −5.84. The wearable electronic device 400 according to an embodiment of the disclosure may improve the performance of the antenna by about 2.79 dB compared to a comparative wearable electronic device.

The wearable electronic device may dispose an antenna pattern on a semiconductor packaging substrate (e.g., a SiP substrate), thereby increasing the area of the antenna pattern and improving the antenna performance.

The disclosure enables a wearable electronic device to increase an area of an antenna pattern and improve antenna performance by disposing an antenna pattern on an antenna carrier and a semiconductor packaging substrate, such as a SiP substrate.

A wearable electronic device (e.g., the wearable electronic device 400 of FIGS. 4 to 6) according to various embodiments of the disclosure may include: a first antenna structure (e.g., the first antenna structure 1220 of FIG. 12, the first antenna structure 1320 of FIG. 13, the first antenna structure 1520 of FIG. 15, the first antenna structure 1720 of FIG. 17) disposed on an antenna carrier (e.g., the antenna carrier 810 of FIG. 8, the antenna carrier 1310 of FIG. 13, the antenna carrier 1510 of FIG. 15, the antenna carrier 1710 of FIG. 17), a printed circuit board (e.g., the printed circuit board 1230 of FIG. 12, the printed circuit board 1330 of FIG. 13, the printed circuit board 1530 of FIG. 15, the printed circuit board 1730 of FIG. 17, the printed circuit board 1930 of FIG. 19), a semiconductor packaging substrate packaged with the printed circuit board 1230, 1330, 1530, 1730, and 1930 (e.g., the semiconductor packaging substrate 850 of FIG. 8, the semiconductor packaging substrate 1340 of FIG. 13, the semiconductor packaging substrate 1540 of FIG. 15, the semiconductor packaging substrate 1740 of FIG. 17, the semiconductor packaging substrate 1940 of FIG. 19), a second antenna structure (e.g., the second antenna structure 1250 of FIG. 12, the second antenna structure 1350 of FIG. 13, the second antenna structure 1570 of FIG. 15, the second antenna structure 1780 of FIG. 17, the second antenna structure 1980 of FIG. 19) disposed on at least a portion of a surface of the semiconductor packaging substrate 850, 1340, 1540, 1740, and 1940, and a contact structure (e.g., the contact structure 1260 of FIG. 12, the contact structure 1360 of FIG. 13, the contact structure 1560 of FIG. 15, the contact structure 1760 of FIG. 17, the contact structure 1960 of FIG. 19) electrically connecting the first antenna structure 1220, 1320, 1520, and 1720 with the second antenna structure 1250, 1350, 1570, 1780, and 1980.

According to one embodiment of the disclosure, a processor, memory, and electronic components may be disposed on a first surface (e.g., a front surface) of the printed circuit boards 1230, 1330, 1530, 1730, and 1930. At least a portion of the second antenna structure 1250, 1350, 1570, 1780, and 1980 may be disposed on a second surface (e.g., a rear surface) opposite the first surface (e.g., the front surface) of the semiconductor packaging substrate 850, 1340, 1540, 1740, and 1940.

According to one embodiment of the disclosure, at least a portion of the second antenna structure 1250, 1350, 1570, 1780, and 1980 may be disposed on a third surface (e.g., a side surface) positioned perpendicular to the first side (e.g., the front surface) and the second surface (e.g., the rear surface) of the semiconductor packaging substrate 850, 1340, 1540, 1740, and 1940.

According to one embodiment of the disclosure, an antenna pattern of the second antenna structure 1250, 1350, 1570, 1780, and 1980 may be disposed on at least one of the second surface (e.g., the rear surface) and the third surface (e.g., the side surface) of the semiconductor packaging substrate 850, 1340, 1540, 1740, and 1940.

According to one embodiment of the disclosure, a main feed of the second antenna structure 1250, 1350, 1570, 1780, and 1980 may be formed on at least a portion of the surface of the semiconductor packaging substrate 850, 1340, 1540, 1740, and 1940.

According to one embodiment of the disclosure, a shorting feed of the second antenna structure 1250, 1350, 1570, 1780, and 1980 may be formed on at least a portion of the surface of the semiconductor packaging substrate 850, 1340, 1540, 1740, and 1940.

According to one embodiment of the disclosure, an antenna ground of the second antenna structure 1250, 1350, 1570, 1780, and 1980 may be formed on at least a portion of the surface of the semiconductor packaging substrate 850, 1340, 1540, 1740, and 1940.

According to one embodiment of the disclosure, the antenna ground of the second antenna structure 1250, 1350, 1570, 1780, and 1980 may be formed on all or part of a rear surface of the semiconductor packaging substrate 850, 1340, 1540, 1740, and 1940.

According to one embodiment of the disclosure, the antenna ground of the second antenna structure 1250, 1350, 1570, 1780, and 1980 may be formed on all or a portion of a side surface of the semiconductor packaging substrate 850, 1340, 1540, 1740, and 1940.

According to one embodiment of the disclosure, the antenna pattern may include a loop antenna pattern.

A wearable electronic device 400 according to an embodiment of the disclosure may include a printed circuit board 2230, 2330, 2430, 2530, 2630, 2730, and 2830), a semiconductor packaging substrate 2240, 2340, 2440, 2540, 2640, 2740, and 2840 packaged with the printed circuit board 2230, 2330, 2430, 2530, 2630, 2730, and 2830, an antenna structure 2250, 2350, 2450, 2550, 2560, 2750, and 2850 disposed on at least a surface of the semiconductor packaging substrate 2240, 2340, 2440, 2540, 2640, 2740, 2840, 2540, 2640, 2740, and 2840, an antenna structure 2250, 2350, 2450, 2550, 2560, 2750, and 2850 disposed on at least a portion of a surface of the semiconductor packaging substrate 2240, 2340, 2440, 2540, 2640, 2740, and 2840, and a contact structure 2250, 2350, 2450, 2550, 2560, 2750, and 2850 electrically connecting the antenna structure with the printed circuit board 2230, 2330, 2430, 2530, 2630, 2730, and 2830.

According to one embodiment of the disclosure, a processor, memory, and electronic components may be disposed on a first surface (e.g., a front surface) of the printed circuit board 2230, 2330, 2430, 2530, 2630, 2730, and 2830. At least a portion of the antenna structure may be disposed on a second surface (e.g., a rear surface) that is opposite the first surface (e.g., the front surface) of the semiconductor packaging substrate 2240, 2340, 2440, 2540, 2640, 2740, and 2840.

According to one embodiment of the disclosure, at least a portion of the antenna structure may be disposed on a third surface (e.g., a side surface) positioned perpendicular to the first surface (e.g., the front surface) and the second surface (e.g., the rear surface) of the semiconductor packaging substrate 2240, 2340, 2440, 2540, 2640, 2740, and 2840.

According to one embodiment of the disclosure, an antenna pattern of the antenna structure may be disposed on at least one of the second surface (e.g., the rear surface) and the third surface (e.g., the side surface) of the semiconductor packaging substrate 2240, 2340, 2440, 2540, 2640, 2740, and 2840.

According to one embodiment of the disclosure, a main feed of the antenna structure may be formed on at least a portion of a surface of the semiconductor packaging substrate 2240, 2340, 2440, 2540, 2640, 2740, and 2840.

According to one embodiment of the disclosure, a shorting feed of the antenna structure may be formed on at least a portion of the surface of the semiconductor packaging substrate 2240, 2340, 2440, 2540, 2640, 2740, and 2840.

According to one embodiment of the disclosure, an antenna ground of the second antenna structure 1250, 1350, 1570, 1780, and 1980 may be formed on at least a portion of the surface of the semiconductor packaging substrate 2240, 2340, 2440, 2540, 2640, 2740, and 2840.

According to one embodiment of the disclosure, the antenna ground of the antenna structure may be formed on all or part of a rear surface of the semiconductor packaging substrate 2240, 2340, 2440, 2540, 2640, 2740, and 2840.

According to one embodiment of the disclosure, the antenna ground of the antenna structure may be formed on all or part of a side surface of the semiconductor packaging substrate 2240, 2340, 2440, 2540, 2640, 2740, and 2840.

According to one embodiment of the disclosure, the antenna pattern may include a loop antenna pattern.

A wearable electronic device (a TWS wireless earphone) according to an embodiment of the disclosure may include a first antenna structure disposed on an antenna carrier, a second antenna structure disposed on at least a portion of a surface of a semiconductor packaging substrate, and a contact structure electrically connecting the first antenna structure and the second antenna structure.

A wearable electronic device (a TWS wireless earphone) according to an embodiment of the disclosure may have a second antenna structure (e.g., a second antenna pattern) disposed on at least a portion of a second surface (e.g., a rear surface) and/or a third surface (e.g., a side surface) of a semiconductor packaging substrate, thereby increasing an area of an overall antenna pattern of the wearable electronic device and improving antenna performance.

The disclosure may provide a wearable electronic device with an antenna carrier and an antenna pattern disposed on a semiconductor packaging substrate (e.g., a SiP substrate), thereby increasing an area of the antenna pattern and improving antenna performance.

It will be appreciated that various embodiments of the disclosure according to the claims and description in the specification can be realized in the form of hardware, software or a combination of hardware and software. Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
a first antenna structure disposed on an antenna carrier;
a printed circuit board;
a semiconductor packaging substrate packaged with the printed circuit board;
a second antenna structure disposed on at least a portion of a surface of the semiconductor packaging substrate; and
a contact structure electrically connecting the first antenna structure and the second antenna structure.

2. The wearable electronic device of claim 1,
wherein one or more processors, memory storing one or more computer programs, and electronic components are disposed on the first surface of the printed circuit board, and
wherein at least a portion of the second antenna structure is disposed on a second surface opposite to the first surface of the semiconductor packaging substrate.

3. The wearable electronic device of claim 2, wherein at least a portion of the second antenna structure is disposed on a third surface positioned in a direction perpendicular to the first surface and the second surface of the semiconductor packaging substrate.

4. The wearable electronic device of claim 3, wherein an antenna pattern of the second antenna structure is disposed on at least one of the second surface and the third surface of the semiconductor packaging substrate.

5. The wearable electronic device of claim 4, wherein a main feed of the second antenna structure is formed on at least a portion of the surface of the semiconductor packaging substrate.

6. The wearable electronic device of claim 4, wherein a shorting feed of the second antenna structure is formed on at least a portion of the surface of the semiconductor packaging substrate.

7. The wearable electronic device of claim 4, wherein an antenna ground of the second antenna structure is formed on at least a portion of the surface of the semiconductor packaging substrate.

8. The wearable electronic device of claim 7, wherein the antenna ground of the second antenna structure is formed on all or a portion of a rear surface of the semiconductor packaging substrate.

9. The wearable electronic device of claim 7, wherein the antenna ground of the second antenna structure is formed on all or a portion of a side surface of the semiconductor packaging substrate.

10. The wearable electronic device of claim 4, wherein the antenna pattern comprises a loop antenna pattern.

11. A wearable electronic device comprising:
a printed circuit board;
a semiconductor packaging substrate packaged with the printed circuit board;
an antenna structure disposed on at least a portion of a surface of the semiconductor packaging substrate; and
a contact structure electrically connecting the printed circuit board and the antenna structure.

12. The wearable electronic device of claim 11,
wherein one or more processors, memory storing one or more computer programs, and electronic components are disposed on a first surface of the printed circuit board, and
wherein at least a portion of the antenna structure is disposed on a second surface opposite to a first surface of the semiconductor packaging substrate.

13. The wearable electronic device of claim 12, wherein at least a portion of the antenna structure is disposed on a third surface positioned in a direction perpendicular to a first surface and the second surface of the semiconductor packaging substrate.

14. The wearable electronic device of claim 13, wherein an antenna pattern of the antenna structure is disposed on at least one of the second surface and the third surface of the semiconductor packaging substrate.

15. The wearable electronic device of claim 14, wherein a main feed of the antenna structure is formed on at least a portion of the surface of the semiconductor packaging substrate.

16. The wearable electronic device of claim 14, wherein a shorting feed of the antenna structure is formed on at least a portion of the surface of the semiconductor packaging substrate.

17. The wearable electronic device of claim 14, wherein an antenna ground of a second antenna structure is formed on at least a portion of the surface of the semiconductor packaging substrate.

18. The wearable electronic device of claim 17, wherein the antenna ground of the antenna structure is formed on all or a portion of a rear surface of the semiconductor packaging substrate.

19. The wearable electronic device of claim 17, wherein the antenna ground of the antenna structure is formed on all or a portion of a side surface of the semiconductor packaging substrate.

20. The wearable electronic device of claim 14, wherein the antenna pattern comprises a loop antenna pattern.
